(19) United States
(12) Patent Application Publication
(10) Pub. No.: US 2026/0316371 A1
(43) Pub. Date: Oct. 15, 2026

(54) A METHOD OF THERMOFORMING PLASTICS CONTAINERS

(71) Applicant: Par-Par Europe Limited, London (GB)

(72) Inventors: Keith HARRISON-TRUELOVE, Milton Keynes Buckinghamshire (GB); Fraser GRAHAM, Blackburn (GB); Erica SKYRME, London (GB)

(21) Appl. No.: 19/117,296

(22) PCT Filed: Oct. 9, 2023
(86) PCT No.: PCT/GB2023/052611

§ 371 Date: Mar. 31, 2025

(30) Foreign Application Priority Data
Oct. 7, 2022 (GB) 2214806.8

(51) Int. Cl. B29C 51/26; B29C 51/08; B29C 51/42; B29C 71/02; B29K 67/00; B29K 105/00; B29L 31/00

(52) U.S. Cl. CPC B29C 51/266; B29C 51/082; B29C 51/427; B29C 71/02; B29C 2071/022; B29K 2067/00; B29K 2105/256; B29K 2995/004; B29L 2031/712

(57) ABSTRACT

A method of forming a plastics container, the container so formed, and a kit in parts for use in the method. The method including receiving a thermoplastic material having a first temperature above the glass transition temperature and below a melting temperature of said thermoplastic material; and moulding the received thermoplastic material to form an intermediate article; stretching the received thermoplastic material to provide at least 20% strain-induced crystallinity (SIC) across the substantially horizontal region of the intermediate article, and heating to an annealing temperature greater than the first temperature for a period of from 0.5 second to 5 seconds, and subsequently cooling to a quenching temperature below the glass transition temperature to provide a rigidified intermediate article.

### FIELD OF THE INVENTION

The present invention is in the technical field of thermoforming plastics containers. The present invention also extends to thermoformed plastics containers themselves and mould apparatus for forming said containers.

### BACKGROUND TO THE INVENTION

Thermoforming is a method which usually involves heating a thermoplastic material until it is pliable and forming it using a mould to specific shapes. The shaped material is then cooled to result in an end-use product, such as a container. Compared to other conventional methods, thermoforming enables production of containers of different shapes and sizes, usually in an economical way and with high throughput.

Thermoforming may be used to form containers of different grades (e.g. food-grade plastics containers). Some thermoformed food-grade plastics containers are used for foods to be heated, either while still in the container, or immediately prior to filling in the container. Such containers formed by traditional thermoforming techniques, and suitable to receive hot food, or to be exposed to oven temperatures, are typically opaque, which prevents consumers from observing and inspecting the contents (e.g. food) held within said containers.

It is in this context that the present inventions have been devised.

### SUMMARY OF THE INVENTION

In a first aspect of the invention, there is provided a method of forming a plastics container, the method comprising: receiving a thermoplastic material, the thermoplastic material having a first temperature above the glass transition temperature and below a melting temperature of said thermoplastic material; and moulding the received thermoplastic material to form an intermediate article defining: a base; one or more side walls extending therefrom; and a further portion having a surface area greater than 20% greater than a projected surface area of the further portion, projected onto a plane of the received thermoplastic material, the further portion extending from a substantially horizontal region of the intermediate article having a surface area less than 20% greater than a projected surface area of the substantially horizontal region of the intermediate article, projected onto the plane of the received thermoplastic material, wherein the moulding of the received thermoplastic material comprises: stretching the received thermoplastic material to provide at least 20% strain-induced crystallinity, SIC, across the substantially horizontal region of the intermediate article; and heating to an annealing temperature greater than the first temperature for a period of from 0.5 second to 5 seconds, and subsequently cooling to a quenching temperature below the glass transition temperature to provide the rigidified intermediate article.

It will be understood that moulding the received thermoplastic material means moulding said material that has the temperature above the glass transition temperature and below the melting temperature of said material. It will be further understood that the further portion described herein is different from the one or more side walls. Further, the one or more side walls typically contain at least 20% SIC throughout.

Herein, the percentage of strain induced crystallinity (SIC) described refers to percentage of the volume of the thermoplastic material that is crystalline. It will be understood that SIC can be analytically determined. SIC can be measured by any known and effective method, for example ISO 11357-3 or ASTM 793-06. It will be understood that the SIC can be measured by a method as set out below: Differential Scanning Calorimetry (DSC) with a liquid nitrogen cooling accessory can be used. A sample (e.g. about 10 mg) of the region of the intermediate article (or the resulting plastics container) to be tested is subjected to a first heating scan (e.g. from 20 °C to 320 °C at 20 °C/min), followed by a cooling scan (e.g. from 320 °C to 20 °C at 20 °C/min) and then is heated again for a second heating scan (e.g. from 20 °C to 320 °C at 20 °C/min). The glass transition temperature (Tg) can be measured from the second heating scan. The melting temperature (Tm) can be measured from the second heating scan. The heat of melting (ΔHₘ₁, J/g) can be measured during the first heating scan. The heat of crystallization (ΔH_{c1}, J/g) can also be measured during the first heating scan. The percentage of SIC described herein can be determined by the following equation:

SIC%=(ΔHₘ₁−|ΔH_{c1}|)/ΔH⁰×100%

in which ΔH⁰ is the heat of fusion (J/g) corresponding to 100% crystallinity of the received thermoplastic material. For example, if said material is recycled polyethylene terephthalate (rPET), heat of fusion for 100% crystallinity rPET is approximately 140.1 J/g. The method of measuring SIC described herein may be referred to as a ‘DSC method’. Of course, it will be understood that other methods of measuring SIC, glass transition temperature, and melting temperature, are widely known.

Herein, terms such as ‘upward(ly)’, ‘downward(ly)’, ‘up’, ‘upper’, ‘top’, ‘low’, ‘lower’, ‘down’, ‘below’, ‘above’, ‘beyond’, when employed in respect of objects such as the container, the intermediate article, the kit, and their constituent parts or preforms, unless specified otherwise, refer to when said object is in an upright orientation. For example, the base is at the bottom of said object, and an opening of the container used for filling content (e.g. food) being at the top of said object.

The heating to the annealing temperature may be for a period of up to three seconds. It may be that the heating to the annealing temperature is heating of the stretched thermoplastic material. It may be that the heating to the annealing temperature is heating throughout the stretched thermoplastic material. The period of time for which the stretched thermoplastic material is heated may not even be considered to have started until the stretched thermoplastic material has reached the annealing temperature.

The present method provides a method of thermoforming plastics containers (e.g., food-grade plastics containers) which can retain structural integrity of the side walls and the base during use, and in some examples, can also retain transparency in the substantially horizontal region of the intermediate article (and so the container), even when heated to elevated (e.g. oven) temperatures, such as temperatures over 140 degrees Celsius, whilst also providing a container which does not unacceptably deform during such heating. It is believed that the present method makes up the deficiencies of the traditional thermoforming method by providing a high degree of strain induced crystallinity (SIC), especially at substantially horizontal regions of the container such as the rim and/or the base of the container. In the present method, the thermoplastic material is stretched to introduce the SIC across the substantially horizontal region. High degree of SIC (i.e. at least 20%) gives good molecular alignment and/or orientation (e.g. high degree of biaxial orientation which increases material toughness and strength in a thermoplastic container). This leads to a thermostable container (e.g. container that does not unacceptably deform or melt) under elevated temperatures, and additionally, the container may also be stable under cold temperatures. The substantially horizontal region is typically a flat region.

In prior thermoforming methods, the moulding is initiated from a central portion of the received material (e.g., a central portion defines a central part of the base of the intermediate article) and continues in order to provide stretch to other portions of the material (e.g. the portions that define the side walls), which makes it difficult to provide adequate stretch to the stating portion that corresponds to the central region of the base of the container. In addition, the portions that define the upper edge (e.g. the rim of the container) are usually fixed (e.g. by clamping) in positions above a mould to prevent the material from shifting during moulding, such that those portions may have little stretch or even no stretch at all. As a result, the container obtained does not have sufficient SIC across its substantially horizontal regions (e.g. the base and the rim), therefore resulting in these regions being opaque when subject to heating to temperatures over approximately 140 degrees Celsius after manufacture of the container.

By providing a further portion extending from the substantially horizontal region (e.g. the base and/or the rim), the further portion may provide a starting point for the stretch to be built up in advance of a substantially horizontal region of the received material (e.g. the substantially horizontal region that defines at least part of the base), thus facilitating sufficient stretch of the substantially horizontal region such that at least 20% SIC is provided therein. It may also be that during moulding, at least part of the further portion (e.g. the upper edge of the further portion) is clamped in position above a mould cavity, instead of the originating part of the material that corresponds to the substantially horizontal region (e.g. the rim), as is typically the case in prior thermoforming methods for plastics containers. In this way, the part of the received material corresponding to the substantially horizontal region (e.g. the rim) can be properly stretched (e.g. relative to the base) within the mould, in accordance with the shapes, dimensions and configurations of the mould used. Thus, the presence of the further portion ensures sufficient stretching of the substantially horizontal region. As a result, the container so obtained has sufficient SIC (i.e. at least 20% SIC) in (at least) the substantially horizontal region (e.g. the rim and/or the base) to cause said region of the container to remain substantially transparent even when subsequently heated to over temperatures, such as temperatures over 140 degrees Celsius.

It will be understood that, for the purposes of the present disclosure, a portion of the container will be considered to be substantially transparent where at least 90% of the visible light incident thereon is transmitted through the portion of the container. In other words, where the portion of the container is at least 90% visible light transmissive.

The further portion may have a surface area at least 50% greater than a projected surface area of the further portion, projected onto a plane of the received thermoplastic material. The surface area may be at least 100% greater, such as at least 150% greater, or even at least 300% greater. In other words, the further portion is a relatively steep portion, with respect to the plane of the received material. It will be understood that the plane of the received thermoplastic material may alternatively or additionally be considered to be the plane of the base of the intermediate article when formed.

Herein, the substantially horizontal region refers to a region having a surface area less than 20% greater than, such as less than 10% greater than, for example less than 5% greater than a projected surface area of the substantially horizontal region, projected onto the plane of the received thermoplastic material. In some examples, it may be that the substantially horizontal region refers to a region having a surface area substantially equal to (e.g. equal to) a projected surface area of the substantially horizontal region, projected onto the plane of the received thermoplastic material. As hereinbefore, it will be understood that the plane of the received thermoplastic material may alternatively or additionally be considered to be the plane of the base of the intermediate article when formed. The substantially horizontal region may provide (e.g. be) the rim and/or the base of the resultant plastics container (when formed). Said rim and/or said base may comprise (e.g. be) the substantially horizontal region. It will be further understood that the one or more side walls extend between the rim and the base.

In the context of the present invention, the further portion may extend (upwardly) from the substantially horizontal region (e.g. the rim and/or the base). The further portion may extend (upwardly) from the part of the received material corresponding to the rim (of the resultant container). The further portion may extend (upwardly) from the substantially horizontal region that provides the rim opposite the base, wherein optionally the further portion forms a collar extending from said rim. The substantially horizontal region may provide (at least part of) the rim. The rim may comprise (e.g. be) the substantially horizontal region. Additionally or alternatively, the further portion may extend (upwardly) from the part of the received material corresponding to the base of the intermediate article and/or the base of the resultant container. The further portion may extend (upwardly) from the substantially horizontal region to form a protrusion with respect to the base, wherein the base comprises (e.g. is) the substantially horizontal region and optionally said region defines an annulus and further optionally, said region defines an annular region surrounding the protrusion. It will be understood that the further portion is different from the side wall of the intermediate article or the side wall of the correspondingly resultant container.

It will be understood that the further portion itself may or may not have sufficient stretch throughout to ensure that the further portion would remain transparent and substantially rigid when exposed to elevated temperatures subsequent to forming. Thus, the further portion may contain less percentage SIC than the substantially horizontal region of the intermediate article. At least part of the further portion may contain less than 20% SIC throughout, such as less than 10%, for example less than 5%.

The method may further comprise removing (e.g., cutting or trimming off) the further portion from the rigidified intermediate article. Typically, it will be that the further portion is removed to leave the base, the one or more side walls and the substantially horizontal region (if different from the base) of the intermediate article. After removal, the container may have increased percentage SIC, thus increased strength and durability. After removal, the container may contain at least 20% SIC across said container, or at least 25%, or at least 30%, or at least 40%. The further portion can be removed by any effective technique. For example, a cutting apparatus may be employed. Alternatively, the further portion may remain attached to the article for removal later (via perforations or a line of weakening) or may be left as a feature of the intermediate article. It will be understood that cooling to a quenching temperature below the glass transition temperature rigidifies the intermediate article and forms a container. Thus, the rigidified intermediate article (with the further portion) may be considered to be the plastics container. The method may comprise removing the further portion from the rigidified intermediate article. Thus, the rigidified intermediate article without the further portion may be considered to be the plastics container.

It will be understood that in the present invention, stretching the received thermoplastic material may comprise stretching an originating part of the received thermoplastic material that corresponds to the further portion, to provide the at least 20% SIC across the substantially horizontal region of the intermediate article. It may be that the at least 20% SIC is at least 25% SIC, for example at least 30% SIC, such as at least 40% SIC. The high level of SIC provides a sufficiently high level of strength, durability and visible light transmissivity of the resultant container when heated to oven temperatures. The originating part corresponding to the further portion may itself be stretched, such that during moulding, stretching may be continued therefrom with ease to the part corresponding to the substantially horizontal region. In this way, the stretching of the originating part corresponding to the further portion simplifies the stretching of the substantially horizontal region, resulting in high level of SIC across said substantially horizontal region. It will be further understood that each of the substantially horizontal region of the resultant container, and the one or more side walls of the intermediate article and of the resultant container may have at least 20% SIC throughout.

In the context of the present invention, it will be understood that at least 20% SIC is a level of SIC sufficient to ensure that the substantially horizontal region in the formed plastics container remains transparent when subsequently heated to a design temperature above the glass transition temperature for at least one minute. Typically, the formation of SIC by stretch leads to small particle size of the crystals. Typically, the substantially horizontal region (of the intermediate article and of the container) comprises (e.g. consists of) crystals having a maximum dimension of 500 nm, for example a maximum dimension of 300 nm, such as 100 nm, in particular 50 nm. Typically, the side walls (of the intermediate article and of the container) comprise (e.g. consist of) crystals having a similar (e.g. same) size to those in the substantially horizontal region. Typically, crystals having a similar (e.g. same) size to those in the substantially horizontal region are dispersed throughout the container. Those small particles are not visible to the naked eye. Thus, when heated (e.g. in an oven), the substantially horizontal region as well as some if not substantially all of the one or more side walls of the container remains transparent, allowing the consumer to see how well the content is cooked. Herein, transparency may be measured by any suitably known technique, for example, by placing the relevant part of the container in a light path of a spectrophotometer and measuring the transmittance of the visible light, as a percentage of visible light transmitted through air. The technique may be in accordance with ISO 3538, part 5.1 regular luminous transmission test. ‘Transparent’ as used in the context of the present invention denotes to light transmission of the relevant part of the container or the container per se, of at least 60%, or at least 70%, or at least 80%, or at least 90% (e.g. as compared to the transmission through air). A design temperature or an elevated temperature (e.g. oven temperature) typically means a temperature of from 100 °C to 200 °C, or from 120 °C to 180 °C, or from 130 °C to 150 °C. Said temperature may be 140 °C. The substantially horizontal region of the container, optionally the side walls of the container, may remain transparent when heated to the design temperature for at least 1 minute, or at least 5 minutes, or at least 20 minutes, or at least 40 minutes (e.g. 45 minutes), but optionally not more than 1 hour, or not more than 50 minutes. In addition, it will be understood that the container may also be suitable for use at cold temperatures, such as around or below 0 °C.

The substantially horizontal region may (at least partially) provide a rim of the container, wherein the one or more side walls extend between the base and the rim. The rim may comprise (e.g. be) the substantially horizontal region. The rim may include a lid-engaging structure and/or a sealing surface structure. The lid-engaging structure may be configured to engage a lid. The sealing surface structure may be configured to allow a lid member (e.g. a film lid) to be adhered thereto to close the container. The rim may have a planar surface, or a substantially planar surface. The substantially horizontal region may provide (at least part of) the lid-engaging structure and/or (at least part of) the sealing surface structure. It will be understood that the rim may be comprised in the intermediate article. It will be understood that the rim may be comprised in the corresponding resultant container. As previously explained, it is typically difficult to form the rim (as a substantially horizontal region) by a traditional method in such a way that sufficient SIC is provided that the rim remains transparent when heated to the design temperature, after the container has been formed. In the present method, a further portion may be provided extending from the rim. During moulding, the originating part of the received material corresponding to the distal edge of the further portion (distal from the part of the further portion which is adjacent to the rim) may be clamped, rather than the originating part of the material that corresponds to the rim. In this way, the originating part corresponding to the rim is allowed to be stretched to provide at least 20% SIC across the rim. The rim of the intermediate article and the rim of the resultant container may comprise (i.e. consist of) at least 20% SIC throughout, or at least 25%, or at least 30%, or at least 40%.

The further portion may extend from the rim opposite the base. Thus, the further portion may permit the originating part of the received material corresponding to the rim to be stretched upwardly opposite the base. Concurrently, a part of the material that corresponds to the side walls can also be stretched (upwardly). In this way, the parts correspond to the rim and the side walls can be stretched upwardly with respect to the base in one action, simplifying the moulding process. In the present invention, the rim may extend from the side wall. The rim may extend from the periphery (e.g. the upper peripheral edge) of the side wall. The rim may extend around the periphery (e.g. the upper peripheral edge) of the side wall. The rim may extend outwardly or inwardly (preferably outwardly) from the side wall to form a (peripheral) flange, and optionally, the width of the flange is from 1 mm to 10 cm, or from 0.3 cm to 5 cm, or from 0.5 cm to 2 cm. Herein, unless specified otherwise, outward(ly) means a direction leading away from the base, and inward(ly) means a direction leading towards the base. It will be understood that the rim may have a perimeter. The flange typically extends outwardly from the side wall. The flange typically comprises an inner perimeter and an outer perimeter. The outer perimeter is typically larger than the inner perimeter. The rim and/or the flange may have a variety of shapes and dimensions. The shape may be the same or similar to that of the base. For example, the shape may be spherical, hemispherical, oval, polygonal (e.g. square, rectangular), typically spherical or substantially spherical. The rim may optionally be an annular rim. The further portion may extend from the rim to form a collar. The further portion may extend upwardly with respect to the base. Additionally or alternatively, the further portion may extend outwardly away from the base. The further portion may extend from the perimeter of the rim, optionally to form a collar. The further portion may extend from the outer perimeter of the flange, optionally to form a collar. The collar may be a peripheral collar. The size of the collar may be in proportion to the size of the rim, to enable adequate stretch in the rim. Typically, the height of the collar is at least 10% of the perimeter of the rim (or at least 10% of the outer perimeter of the flange), or at least 20%, or at least 30%, but optionally not more than 100%, or not more than 50%. The height of the collar may be from 1 cm to 20 cm, or from 3 cm to 15 cm, or from 5 cm to 10 cm.

The rim may be formed by first stretching an originating part of the received thermoplastic material that corresponds to the rim, and subsequently exerting a gaseous pressure differential between the inner and outer sides of said part, thereby urging said part outwardly away from the base to form a rim. The gaseous pressure differential may be exerted before or after heating to the annealing temperature, typically before heating to the annealing temperature. In this way, the rim so formed can be heated to the annealing temperature (i.e. annealed) and subsequently cooled to the quenching temperature (i.e. quenched), in order to obtain a rigidified rim. It is alternatively possible for the gaseous pressure differential to be exerted after heating to the annealing temperature (e.g. after annealing) and before cooling to the quenching temperature (e.g. before quenching). In this way, the annealed rim can be quenched to obtain a rigidified rim. The exertion of the gaseous differential, the annealing and the quenching do not affect the SIC level such that it drops below the level of SIC required to ensure the resultant rim of the container remains transparent when heated to the design temperature. Since the part corresponding to the rim has been properly stretched, said part contains at least 20% SIC, sufficient to provide the strength as well as transparency of the rim of the resultant container. The rim can be formed by exerting a positive gas pressure (e.g. blowing a pressurized gas) against said stretched part, and/or by exposing an opposite side of the stretched part to a negative gas pressure (e.g. a vacuum pressure).

In the context of the present invention, it may also be that the base comprises the substantially horizontal region, and the further portion extends from said region to form a protrusion with respect to the base. As explained previously, by using a traditional thermoforming method, it may be difficult to obtain a base with sufficient SIC throughout, especially a large, flat base containing at least 20 % SIC throughout by a simple stretch. In the present method, a further portion may be provided extending from the substantially horizontal region (of the base), thus providing a starting point of stretch. Accordingly, this ensures that a greater proportion of the base can contain the required SIC, compared to the situation were the further portion not to be provided. The moulding (e.g. stretching) can then continue in a direction radiating outwardly from the further portion towards the periphery of the base, to provide sufficient stretch across the substantially horizontal region of the base, or sufficient stretch across the base.

Since the further portion is in general a steep portion with respect to a plane of the received thermoplastic material, the further portion may be conveniently constructed as a protrusion with respect to the base. It will be understood that in some examples the base may comprise some regions having sufficient SIC to ensure that those regions remain transparent when heated to the design temperature, whilst still containing other regions which do not have the required SIC, meaning that those other regions would become opaque during heating of the container to the design temperature. Importantly, the positioning and proportion of regions of the base having sufficient SIC are chosen so as to ensure the required structural and visual properties of the container.

The substantially horizontal region may define an annulus.

Specifically, the substantially horizontal region (e.g. the substantially horizontal region comprised in the base) may define an annular region surrounding the protrusion. For example, the protrusion may be disposed in a central region of the base. In other words, the protrusion may not be adjacent to the one or more side walls. In this way, the protrusion is well suited to facilitating the stretching across the substantially horizontal region of the base, rather than just a small section (e.g. a corner) of the base. The disposition of the protrusion may be corresponding to the one or more openings comprised in the base of the correspondingly resultant container. For instance, the base of the container may comprise opening(s) to allow drainage and/or flow of air, or to allow people to push the content out of the container by getting their fingers or hands through the openings. A cheesecake container may comprise a relatively large opening in the central region of the base. The opening can be conveniently formed by removing (e.g. trimming) the further portion (e.g. the protrusion) from the base, after the corresponding intermediate article is cooled and rigidified. As discussed previously, the further portion itself may or may not contain sufficient SIC. Thus, the removal of the protrusion does not affect the strength and transparency of the resultant container. The protrusion with respect to the base may be removed (e.g. trimmed or cut off) from the rigidified intermediate article. As said, the removal may leave an opening in the base of the correspondingly resultant container. The area of the opening may be from 1 cm² to 20 cm², or from 2 cm² to 15 cm², or from 3 cm² to 10 cm², or from 4 cm² to 6 cm². The area of the opening may be from 1% to 50% relative to the whole area of the base of the resultant container (excluding the opening itself), or from 2% to 30%, or from 5% to 20%.

To provide sufficient stretch to the base of the intermediate article, the height of the protrusion is desirably in proportion to the perimeter of the base. Typically, the height of the protrusion is from 5% to 50% of the perimeter of the base, or from 10% to 40%, or from 15% to 20%.

The protrusion may be conical or frustoconical in shape, typically frustoconical in shape. The frustoconical shape may be conveniently executed during moulding (e.g. stretching) by using a plug with a depression defined therein, without breaking any part of the received plastic material, although other shapes of the protrusion may also be possible. The frustoconical shape may comprise a surface opposite the base (e.g. a top surface), and a frustoconical side wall extending from said surface at an angle from 90 to 170 degrees relative to said surface, or from 100 to 130 degrees. The frustoconical side wall may be directly connected to the base. The frustoconical shape may have a hollow interior (e. g, the frustoconical shape may not have a surface opposite to its top surface. In other words, the frustoconical shape may have a virtual bottom surface). The size of said surface opposite the base (e.g. the top surface) may be in proportion to the size of the base of the intermediate article. Said surface opposite the base (e,g. the top surface) may have a surface area of from 5 to 50%, or from 10 to 40%, or from 20% to 30%, relative to the whole surface area of the base. Herein, the frustoconical shape is not part of the base, thus the whole surface area of the base discounts any constituent part (including virtual part) related to the frustoconical shape. Said surface opposite the base (e,g. the top surface) may have a surface area of from 2 cm² to 29 cm² or from 5 cm² to 15 cm², or from 7 cm² to 10 cm².

It may be that the intermediate article defines multiple further portions extending respectively from multiple substantially horizontal regions. For example, the intermediate article may define a first further portion extending from a first substantially horizontal region, and a second further portion extending from a second substantially horizontal region. The first substantially horizontal region may provide (e.g. be) the rim of the intermediate article. The rim may comprise the first substantially horizontal region. The rim may be the rim of the correspondingly resultant container. The rim may be as described herein. The first further portion may be the further portion (e.g. a collar) extending from the rim, as described herein. The second substantially horizontal region may be comprised in the base of the intermediate article. The base may be the base of the correspondingly resultant container. The second substantially horizontal region (e.g. base) may be as described herein. The second further portion may be the further portion (e.g. the protrusion) extending from the base, as described herein.

The first temperature may be between 80 °C and 200 °C, or between 100 °C to 180 °C, or between 105 °C to 120 °C (endpoints contemplated). The first temperature may also be above 80 °C, or above 100 °C, or above 105 °C, but below 200 °C, or below 180 °C, or below 120 °C. Thus, the thermoplastic material is at a sufficiently high temperature, above the glass transition temperature, that it can be reshaped using a mould, but not so high a temperature that it will adhere to the mould surface during moulding.

The thermoplastic material may be heated to the first temperature by known and effective means. For example, the thermoplastic material may be heated by contact with a heated element (i.e. conductive heating), or heated by infrared or near-infrared radiation, or preheated by infrared or near-infrared radiation and then conditioned conductively using contact with the heated element.

The glass transition temperature (Tg) refers to a temperature at which the material, typically a polymer, transits from a hard and brittle ‘glassy’ state into a viscous or rubbery state. The transition is usually reversible. Tg is either well-known or at least can be characterized by well-known techniques such as differential scanning calorimetry (DSC). At a temperature at least equal to Tg, the viscoelastic properties of a material allow flexibility (i.e. the material becomes pliable), as is the case of thermoplastic materials. Herein, a melting temperature (Tm) refers to a temperature at which a thermoplastic material changes its state from a solid to a liquid. The Tm used in this invention refers to Tm measured at 1 atmosphere. The melting point of a thermoplastic material is either already well defined, or at least can be defined by known techniques such as DSC. Herein, Tg and Tm can be determined by using the DSC method, as described hereinbefore.

The moulding of the received material may comprise using a plug to stretch at least part of the received material. The part(s) may correspond to the base, the one or more side walls, and optionally the further portion of the intermediate article. If the resultant container comprises a rim, the part also corresponds to the rim of the intermediate article. Thus, by using a plug, the received material may be stretched to provide sufficient SIC in a particularly effective manner. After stretching, a gaseous pressure differential between the inner and outer sides of the stretched material may be exerted to further shape the stretched article. The gaseous differential does not decrease the SIC level in the stretched material below a level at which transparency in the substantially horizontal region would not be maintained when subsequently heated to the design temperature, and may urge said material against a mould, thereby forming the stretched article. The stretched article may comprise a base, one or more side walls extending therefrom, and a further portion. The stretched article may further comprise an originating part of the received material that corresponds to the rim, wherein said part contains at least 20% SIC throughout. The one or more side walls may extend between said part and the base. The further portion may extend from side part, and/or the further portion may extend from the base. Typically, the further portion extends in a direction upwardly away from the base. Apart from the further portion, the stretched article may comprise at least 20% SIC throughout, or at least 25%, or at least 30%, or at least 40%. Subsequently, the stretched article may be heated to an annealing temperature (i.e. the stretched article may be annealed). In the context of the present invention, the stretched article may be understood as a preform of the intermediate article. The process described above for forming the stretched article (without subsequent annealing) is understood as a first mould stage (i.e. stage 1) of the present method. The first mould stage (i.e. stage-1) may comprise moulding (e.g. stretching) at least part of the received material, thereby forming the stretched article.

The mould used in the first mould stage (i.e. stage-1 mould) may be a male or female mould (typically a female mould). The received material may be moulded (e.g. stretched) in accordance with the shapes and dimensions of the stage-1 mould to form the stretched article. It is understood that the received thermoplastic material (e.g. before presented to the stage-1 mould) has a first temperature above the glass transition temperature and below a melting temperature of said material, for example from 80 °C to 250 °C, or from 80 °C to 220 °C, or from 100 °C to 200 °C, or from 120 °C to 180 °C (e.g. 135 °C). During moulding, the stage-1 mould may have a temperature that is lower than the first temperature. The stage-1 mould may have a temperature of from 10 °C to 70 °C, or from 20 °C to 65 °C, or from 40 °C to 60 °C. For example, the stage-1 mould may have a temperature of 55 °C. A mould apparatus may be used, comprising the stage-1 mould, the plug, and optionally a clamp. During moulding (e.g., stretching), the stage-1 mould is usually arranged below the clamp. An originating part in the received article corresponding to at least part of the further portion may be clamped in place above the stage-1 mould (e.g., by the clamp), which allows the part corresponding to the substantially horizontal region (e.g. the rim) to be stretched (e.g. in accordance with the stage-1 mould). The plug itself may be thermally non-conductive. The plug may comprise (e.g. be formed from) a thermally non-conductive material (e.g. nylon). The plug may have a temperature as described for the stage-1 mould or above that for the stage-1 mould. The plug may have a temperature of from 70 °C to 150 °C, or from 80 °C to 130 °C, such as 100 °C.

The stage-1 mould may define a mould cavity surrounded by an outer moulding surface. The outer moulding surface defines the outer shape of the stretched article to be formed from the received thermoplastic material. The depth of the mould cavity is typically greater than the height of the side wall of the resultant container, for example, at least 5% greater, or at least 10%, or at least 20%. This ensures that the originating part of the received material that corresponds to the substantially horizontal region (e.g. rim) can be stretched within the mould cavity. It may be that the originating part of the received material that corresponds to at least part of the further portion is also stretched (within the mould cavity). Optionally, the depth of the mould cavity is less than 200% of the height of the side wall, or less than 150%.

The stage-1 mould may comprise a rim positioned at the upper edge of said mould (opposite the bottom of the mould cavity). The rim may surround the uppermost opening of the mould cavity. The rim may be provided as a peripheral flange surrounding the uppermost opening of the mould cavity. The rim is optionally annular. The outer moulding surface of the rim may define the corresponding part (e.g. the upper edge) of the outer shape of the stretched article formed from the receive material. It will be understood that said rim does not correspond to or define the rim of the intermediate article nor the rim of the resultant container. The rim and the upper edge of the side wall of the mould cavity may define a corner in the stage-1 mould. Said rim and said side wall may be directly connected via said corner. Typically, at least 50% or at least 75% or 100% of the surface area of the side wall of the mould cavity is inclined at an angle (i.e. a draft angle) of from 1 degree to 20 degrees, or from 5 degrees to 15 degrees, or from 7 degrees to 12 degrees, or about 10 degrees to a longitudinal axis of the mould cavity extending from the bottom of the cavity to the opening of the cavity. Optionally, at least 50%, or at least 75%, or 100% of the surface area of the rim is inclined at an acute angle that is larger than said draft angle (e.g. from 5 degrees to 60 degrees, or from 10 degrees to 50 degrees, or from 20 degrees to 40 degrees) to the longitudinal axis of the mould cavity extending from the bottom of the cavity to its opening. It will be understood that the side wall of the mould cavity and/or the rim is typically inclined outwardly (in a direction leading away from the base of the mould). In other words, the opening of the mould cavity is larger than the base of the mould.

The stage-1 mould may comprise a slippery region, optionally the region around the above-described rim of the mould and further optionally around the above-described corner of the mould. The slipperiness facilitates the movement of the received material from the above-described corner towards the bottom of the mould cavity during stretching. The received material may be smoothly stretched over the corner and/or the rim even after contact with the corner and/or the rim of the mould. The slipperiness reduces the risk of the received material sticking to the moulding surface during movement (e.g. stretch), e.g. it reduces the risk of creating unwanted wearing and tearing in the received material when it is stretched in the first stage, especially when it moves around the corner and/or the rim. Thus, the slippery region is well suitable to ensuring stretching as well as providing high level of strain induced crystallinity (SIC) in the stretched article. It is understood that the method may comprise stretching at least part of the received thermoplastic material over a rim of the mould (i.e. stage-1 mould) towards the bottom of the outer moulding surface of said mould, wherein a region of the mould (e.g. a region around said rim) is a slippery region, and wherein optionally said rim is positioned at the upper edge of said mould and further optionally said part of the received thermoplastic material makes a contact with said rim during stretching.

It may be that the stage-1 mould comprises a region formed from a material having a lower coefficient of friction than that of the material forming the stage-2 mould (e.g. the quenching mould and/or the annealing mould) as described hereinbelow. The region may be the slippery region as identified above. It may be that the stage-1 mould is slippery or at least partially slippery. It may be that the stage-1 mould is partly or wholly made from a slippery material. It may be that at least part of or the entire outer moulding surface of the stage-1 mould is slippery (e.g. made from a slippery material). It may be that the stage-1 mould has a slippery coating on part of or the entire outer moulding surface. It may be that the rim region and/or the corner region of the mould is made from a slippery material or has a slippery coating. The slippery material may be selected from polytetrafluoroethylene (PTFE), nylon, (ultra-high-molecular-weight, UHMW) polyethylene, polyethylene terephthalate (PET-P), polyether ether ketone, and suitable mixtures thereof. Preferably, the slippery material is PTFE. The slippery coating may comprise (i.e. be made from) any of the materials or mixtures of the materials listed above. The slippery coating may comprise PTFE or be a PTFE coating. Herein, slippery, slippery material, slippery coating, slipperiness, and the likes refer to materials, coatings and substances that have a low coefficient of friction, allowing objects to slip across the surface with ease. The low coefficient of friction is typically no greater than 0.5, or no greater than 0.2, or no greater than 0.1, or no greater than 0.05, or no greater than 0.02. The coefficient of friction (either static or kinetic) may be expressed as: μ=F/N, wherein F is the frictional force (in Newtons), N is the normal force (in Newtons) and μ is the static or kinetic coefficient of friction (dimensionless). The values of the coefficient of friction (COF) in the context of the present invention may be referred to as the static COF value, or the kinetic COF value, or the average of the two where appropriate. The COF value may be measured by conventionally known and effective techniques, for example, by ASTM D 1894.

The clamp of the mould apparatus may have a lower surface which may clamp against an upper surface of the mould. Typically, the plug has a cylindrical shape. Typically, the plug has a hemispherical end, or a semi-oval end, or a semi-ellipse end. The end of the plug is typically rounded, since the end is the (lower) end engageable with the thermoplastic material during moulding to stretch the material without puncturing it. The plug may comprise an opening (e.g. a through opening), optionally configured to stretch and accommodate the protrusion. The end of the plug typically has a diameter of from 12 mm to 20 mm, or from 14 mm to 18 mm, or 16 mm. The maximum cross-sectional area of the end may be less 25%, or less than 15%, or less than 10%, but at least 2%, or at least 4%, or at least 5%, or at least 8%, of the cross-sectional area of the mould cavity. Optionally, the plug may include a conduit (e.g. a central conduit), for introducing pressurized gas into the mould (e.g. the mould cavity). The outer surface of the plug may include gas outlet hole(s), communicating with the conduit.

During the first mould stage, the plug may be moved to engage part of the thermoplastic material. This may cause the material to deform and stretch downwardly towards the bottom of the mould cavity. The material may thereby form a substantially inverted conical or frustoconical shape. It is also possible to use a male mould. Therefore, during moulding (e.g. stretching), the plug (e.g. the end of the plug) may engage an inner or outer side of at least a portion of the received thermoplastic material, optionally the central portion, and stretch (e.g. axially stretch) at least part of said portion. The plug may engage a part of the received material and may move (axially) towards the bottom of the mould (e.g. the female mould), in order to stretch the received thermoplastic material. The plug may move (e.g. axially) a distance towards the bottom of the mould (e.g., the female mould). A portion, optionally a central portion of the received thermoplastic material, may be stretched (by the plug) by a distance which is from 75% to 100% of the height of the outer moulding surface. The plug may move towards the bottom of the mould (e.g. the female mould) by a distance which is substantially the entire depth of the mould cavity defined by the outer moulding surface. When the plug starts engaging a portion of the received thermoplastic material, the plug starts actuating the material (e.g. stretching the material). Until the moment the plug has finished moving (e.g. the plug has moved to the bottom of the mould cavity or close to the bottom of said cavity), the plug finishes the actuation. The actuation speed of the plug relative to the received material is at least 0.3 m/s, or at least 0.5 m/s, or at least 0.8 m/s, but optionally not more than 50 m/s, or not more than 20 m/s, or not more than 10 m/s, or not more than 5 m/s, or not more than 2 m/s. The actuation speed of the plug can be, therefore, defined by the distance (d) of the plug travels from the engagement point with the thermoplastic material to the point the plug stops travelling (e.g. the point close to or at the bottom of the mould cavity), divided by the time (t) used to travel such a distance. The defined actuation speed may be well suited to providing sufficient SIC without breaking (e.g. tearing apart) the received material. When the plug finishes actuation, the space between the plug (e.g. the end of the plug) and the bottom of the mould cavity is typically at least 2 mm, or at least 5 mm, but optionally not more than 15 mm, or not more than 10 mm. Said space may be 7 mm. The space allows sufficient stretch hence sufficient SIC to be formed during actuation, as well as prevents the material from adhering to the plug by the end of the first mould stage.

After actuation, a gaseous pressure differential may be exerted between the inner and outer sides of the received material. For example, a positive gaseous differential can be exerted (e. g by blowing a pressurized gas against the inner or outer side which urges the opposing side of the material outwardly against the mould). For a further example, a negative gaseous differential can be exerted (e.g., by vacuum sucking). The gas may be output through gas outlet hole(s) comprised in the plug. The pressurised blowing gas may be wholly or partly emitted from the plug. Typically, the gaseous pressure differential may be at least 2 bar, or at least 3 bar, or at least 5 bar (e.g., 5 bar), but optionally not more than 20 bar, or not more than 15 bar, or not more than 10 bar. The numerical ranges of the pressure may be well suited to urging the portion (e.g. the central portion) of the received thermoplastic material radially outwardly against the outer moulding surface of the (female) mould that defines the mould cavity. For example, the received material can be urged outwardly by the gas so as to contact and assume the shape of the side wall(s) and the base of the female cavity. Further, the received thermoplastic material may be urged to assume the shape of the protrusion with respect to the base (e.g. the female cavity may comprise a corresponding protrusion). For example, the material may be urged to assume the frustoconical shape as described herein, or other characteristics of the protrusion(s).

It will be understood that the following features of the stretched article, the intermediate article, the correspondingly resultant container, and the mould, may share similarities or be substantially the same (e.g. same): one or more side walls, the base, and optionally the protrusion.

It will be further understood that the present method may comprise stretching (e.g. during the first stage) an originating part of the received material that corresponds to the protrusion, concurrently with stretching an originating part of the received material that corresponds to the side wall and optionally concurrently with stretching an originating part of said material that corresponds to the base. In this way, the protrusion, the base and the side wall may be at least partially formed during the first mould stage (i.e. at the same stage), which provides simplification of the process as well as adequate stretch in the base and the side wall. It may also be that the originating part of said material that corresponds to the rim is also stretched (e.g. stretched to provide at least 20% SIC throughout) at the same time (i.e., during the first mould stage), although the rim itself may be formed by applying a gaseous differential later (such as after forming of the stretched article but before heating to the annealing temperature, or after annealing the stretched article but before quenching). The stretched article so formed in stage 1 may comprise a base, one or more side walls extending therefrom, and at least one of: (i) a protrusion, and (ii) parts of the received material that correspond to the rim and a further portion extending therefrom, respectively. The protrusion may extend from the base. The part corresponding to the rim may extend from the side walls, and the part corresponding to the further portion may extend from the part corresponding to the rim. The stretched article may comprise at least 20% SIC across the part corresponding to the rim, across the one or more side walls, and optionally across the base.

The heating and cooling may form the second mould stage (i.e. stage 2) of the method. It is understood that sufficient SIC (e.g. at least 20% SIC) has been introduced by stretching the received thermoplastic material (e.g. during the first stage). The high temperature annealing is carried out for a relatively short time period. To this end, without wishing to be bound by any theory, it is believed that the crystals of the high SIC do not significantly grow in size. Also, the high number density of crystals (i.e. at least 20% SIC) provides that adjacent crystals are very closely packed, which minimizes or prevents significant crystal growth. The high number density of small crystals (e.g., the maximum dimension of the crystal is 500 nm) forms a crystal network which is reduced in stress during the annealing process and any shape memory effect within the crystal network is substantially eliminated. The article that is annealed is then subjected to rapid quenching, which prevents any further crystal growth. The annealing and quenching have mechanically and thermally stabilised the crystal network formed as a result of the high strain induced crystallinity. The second mould stage (i.e. stage 2) of the method may therefore comprise annealing and quenching the article, as described herein.

The annealing temperature may be at least 150 °C, or at least 160 °C, or at least 170 °C, or at least 190 °C, but not more than 250 °C, or not more than 220 °C, or not more than 200 °C. The period of annealing is typically greater than 0.5 seconds, or greater than 1 second. The period of annealing is typically less than 5 seconds, or less than 3 seconds, or less than 1.5 seconds. The stretched article may be heated (e.g. annealed) to said temperatures, and optionally for said periods. The chosen temperatures and periods provide enhanced annealing process that better eliminates any shape memory effect. It will be understood that the period of annealing may not be considered to have started until at least the surface temperature and optionally the core temperature of the stretched thermoplastic material, has reached the annealing temperature.

The method may comprise providing the stretched article in contact with an annealing mould for a period (e.g. 0.5 s to 5 s, such as 0.5 s to 3 s), wherein the annealing mould is heated to at least the annealing temperature (as described above), removing contact with the annealing mould, and providing the stretched article in contact with a quenching mould to form the intermediate article, wherein the quenching mould is at or below the quenching temperature, thereby quenching to provide the rigidified intermediate article.

Typically, the quenching temperature is less than 70 °C, or from 0 °C to 70 °C, such as from 10 °C to 30 °C in order to rigidify the intermediate article. The quenching temperature may be less than an ambient temperature (e.g. less than 25 degrees). Typically, the quenching (i. e the cooling) is started within a period of from 0.5 second to 2 seconds from the end of the annealing (i.e. the heating). Typically, the intermediate article is cooled to the quenching temperature within a period of from 0.2 second to 1.5 seconds from the start of the cooling. Typically, the intermediate article is at the quenching temperature for a period of at least 0.2 second, or at least 0.5 second, or at least 1.5 seconds, or at least 2 seconds.

It is understood that the mould apparatus may be used in the second mould stage. The apparatus may include an annealing mould (used for annealing) and a quenching mould (used for quenching). The annealing mould may be a male mould, and the quenching mould may be a female mould. During the second mould stage, the male mould may be heated to the annealing temperature, and the female mould may be at the quenching temperature.

During annealing, the stretched article may be shrunk onto the male mould to anneal, and the article may be located within a moulding cavity of the female mould. After annealing, the article may be expanded to be removed from contact with the male mould, and subsequently placed in contact with the female mould to form the intermediate article. The intermediate article is quenched by the relatively cold, female mould.

The annealing mould (e.g. the male mould) and the quenching mould (e.g the female mould) may be configured to anneal the stretched article and quench the intermediate article respectively. The quenching mould may be a female mould defining a mould cavity surrounded by an outer moulding surface. The outer moulding surface may define the outer shape of the intermediate article and optionally the final moulded container. The apparatus may include an annealing mould which may be a male mould having a moulding surface. The male mould may take the form of a plug. The annealing mould (e.g. the plug) may include a base, one or more side walls extending from the base, and optionally a recess in the base (e.g. a frustoconical recess in the base). The recess may be used to accommodate the protrusion during annealing. It will be further understood that the shapes, dimensions, and configurations of the annealing mould (e.g. the plug) may be the same or substantially the same as those of the stretched article. The annealing mould may have an outer moulding surface which defines the inner shape of the intermediate article and optionally that of the final moulded container.

In addition to the side walls mentioned above, the annealing mould (e.g. the plug) may comprise a further portion having a surface area greater than 20% greater than (e.g. greater than 50% greater than, greater than 100% greater than, greater than 150% greater than, greater than 300% greater than) a projected surface area of the further portion, projected onto a plane of the base of the annealing mould. The further portion typically extends from a substantially horizontal region having a surface area less than 20% greater than (e.g. less than 10% greater than, less than 5% greater than, substantially equal to or equal to) a projected surface area of the substantially horizontal region, projected onto the plane of said base. The substantially horizontal region may provide (e.g. be) a rim of the annealing mould. Thus, it will be understood that the further portion may be a relatively steep portion with respect to the base (or the rim) of the annealing mould. Said rim may comprise the substantially horizontal region. The further portion may be in the form of a collar, optionally extending from the perimeter of the substantially horizontal region (e.g. the rim), further optionally extending upwardly away from the base of the annealing mould. It will be understood that the substantially horizontal region (e.g. the rim) may connect the side wall and the further portion of the annealing mould. The substantially horizontal region (e.g. the rim) may be different from the base of the mould. The substantially horizontal region (e.g. the rim) may be positioned between the side wall and the further portion of the annealing mould.

The shapes and configurations of base, the side wall, the substantially horizontal region (e.g. the rim), and/or the further portion of the annealing mould may correspond respectively to the shapes and configurations of those of the quenching mould as described herein. ‘Correspond’ may be understood to mean the same or substantially the same. The dimensions and the sizes of the base, the side wall, the substantially horizontal region (e.g. the rim), and/or the further portion of the annealing mould may be reduced respectively in comparison to the dimensions and sizes of those of the quenching mould as described herein. In this way, the annealing mould may at least partially fill the moulding cavity of the quenching mould when inserted thereinto.

The method of the present invention may comprise clamping a part of the stretched article by a portion of the annealing mould and a corresponding portion of the quenching mould (thereby forming a rim of the container). Thus, it may be that said part of the stretched article corresponds to the rim of the container. Said part may also correspond to the rim of the intermediate article. The annealing mould and the quenching mould may be configured to clamp said part of the stretched article (to form a rim of the container and/or the rim of the intermediate article). It will be understood that the further portions and the substantially horizontal regions of the annealing and quenching moulds may be so configured. Said part of the stretched article may be clamped between (a portion of) the annealing mould and (a corresponding portion of) the quenching mould (to form said rim).

The portion of the annealing mould may comprise (e.g. be) the substantially horizontal region (e.g. the rim) of the annealing mould; and the portion of the quenching mould may comprise (e.g. be) the substantially horizontal region (e.g. the rim) of the quenching mould. Therefore, method may comprise clamping said part of the stretched article by the substantially horizontal region (e.g. the rim) of the annealing mould and the substantially horizontal region (e.g. the rim) of the quenching mould, (thereby forming a rim of the container and/or the rim of the intermediate article). The substantially horizontal region (e.g. the rim) of the annealing mould may define the inner shape of the rim of the resultant container (and/or the rim of the intermediate article). Said horizontal region (e.g. the rim) may connect the side wall and the further portion of the annealing mould. The substantially horizontal region (e.g. the rim) of the quenching mould may define the outer shape of the rim of the resultant container (and/or the rim of the intermediate article). Said horizontal region (e.g. the rim) may connect the side wall and the further portion of the quenching mould.

Using clamping to form the rim ensures that the SIC obtained in the first stage is retained during the second stage when said rim is so formed. High level of SIC in the rim enhances the structural integrity of the container, especially when the container is used under elevated temperatures (i.e. when the container is used for cooking or reheating food). High level of SIC further helps maintaining the transparency of the container (especially the rim part of the container) under elevated temperatures.

It may be that the annealing mould (e.g. the plug) is provided with thermal insulation. It may be that said insulation is provided by a plate preferably located at the top of the mould (e.g. the plug). The plate may comprise (e.g. be made from) insulating material. Herein, top refers to when the annealing mould is in an upright orientation during operation. For example, the base of the annealing mould is at the bottom, facing the base of the quenching mould; the top of the annealing mould is opposite and away from the base of the quenching mould. Therefore, it may be that the insulation is at the top of the mould (e.g. the plug) opposite the base of the mould (e.g. the plug). It will be understood that the annealing mould (e.g. the plug) may comprise a (top) plate opposite the base, wherein the (top) plate comprise (e.g. is made from) insulating material. The further portion of the annealing mould may extend from the (top) plate, preferably extending downwardly towards the sidewall and/or the base of said mould. The thermal insulation provided by the (top) plate of the anneal mould may reduce heat loss to other parts of the mould apparatus. This also provides the technical benefits of reducing or preventing overheating of the other parts of the apparatus, especially the parts that do not require heating during operation.

The shape, dimension, size, and configuration of the (top) plate of the annealing mould may correspond (e.g. be the same or substantially the same) respectively to those of the (uppermost) opening of the moulding cavity of the quenching mould. Herein, the quenching mould is understood to comprise a mould cavity surrounded by an outer moulding surface. In this way, when the annealing mould (e.g. the plug) and the quenching mould are in a closed configuration (e.g. the annealing mould is at least partially inserted into the quenching mould), the (top) thermal insulating plate of the annealing mould may at least partially seal the opening of the moulding cavity, thereby localising the heat within the moulding cavity to anneal the stretched article more efficiently.

During the second stage, the annealing and quenching moulds can be in an open configuration (e.g., the female mould and the male mould can be mutually spaced to provide a vertical gap therebetween). The quenching mould (e.g. the female mould) can be located below the annealing mould (e.g. the male mould). The annealing and the quenching moulds can be spaced by a gap of from 0.5 cm to 2 cm, or from 0.5 cm to 1.2 cm, such as 0.6 cm. Thus, the stretched article can be located within a moulding cavity of the quenching mould (e.g. the female mould), which eases the process of annealing and quenching. The stretched article can be shrunk onto the heated annealing (male) mould to anneal said article, and subsequently placed in contact with the cooled quenching (female) mould to form the intermediate article.

Typically, the side wall of the stretched article is in contact with the annealing (male) mould, which is at the annealing temperature, and spaced from the quenching (female) mould, which is at the quenching temperature.

After annealing, the stretched article can be expanded so as to be placed in contact with the cooler quenching (female) mould to form the intermediate article, and removed from contact with the annealing (male) mould.

The stretched article can be expanded by applying a gaseous pressure differential between the inner and outer side of the article. The pressure differential can be positive or negative, or both: (i) a positive gas pressure by passing pressurised gas (e.g. through the annealing (male) mould) to apply a positive gas pressure against an inner surface of the stretched article in contact with the annealing (male) mould, and/or a negative (e.g. vacuum) pressure by applying a negative gas pressure (e.g. to a series of vacuum ports which are located in the outer moulding surface of the quenching (female) mould).

The positive gas pressure pushes, and the vacuum pressure sucks, the outer surface of the annealed stretched article against the quenching mould and spaces the annealed stretched article from the annealing mould, thereby forming an intermediate article by contact with the quenching mould. Subsequently, the intermediate article can be quenched in the quenching (female) mould to provide the rigidified intermediate article.

In the present invention, the rim of the intermediate article (as well as of the resultant container) can be formed by first stretching an originating part of the received material that corresponds to the rim (e. g during the first mould stage), and then exerting a gaseous pressure differential between the inner and outer sides of said part to urge said part outwardly away from the base (e.g. during the second mould stage). It will be understood that the gaseous pressure can be exerted after forming the stretched article. The gaseous pressure can be exerted before or after annealing typically before annealing. This allows the rim so formed to be subsequently annealed and quenched. The gaseous pressure can also be exerted after annealing, concurrently with providing the stretched article in contact with the quenching mould.

The quenching mould may comprise a base, one or more side walls extending therefrom, and a further portion having a surface area greater than 20% greater than a projected surface area of the further portion, projected onto a plane of the base, the further portion extending from a substantially horizontal region having a surface area less than 20% greater than a projected surface area of the substantially horizontal region, projected onto the plane of the base. The substantially horizontal region may provide a rim of the quenching mould. The one or more side walls may extend between the base and the rim. The substantially horizontal region (e.g. the rim) may connect the one or more side walls and the further portion. The substantially horizontal region (e.g. the rim) may be between said side walls and said further portion. The rim may comprise (e.g. be) the substantially horizontal region. The outer moulding surface of the rim of the quenching mould may define the outer shape of the rim of the final container or the rim of the intermediate article. The rim of the quenching mould may be configured to form the rim of the container or the rim of the intermediate article. The further portion of the quenching mould is different from the one or more side walls of the quenching mould. The further portion may be in the form of a collar, optionally extending from the perimeter of the substantially horizontal region (e.g. the rim), further optionally extending upwardly away from the base. Additionally or alternatively, the quenching mould may comprise a further portion taking the form of a protrusion with respect to the base, wherein the protrusion extends from the base. Thus, by applying the gaseous pressure differential, the stretched article can be expended so as to assume the shape of the rim (and optionally the further portion), which can be subsequently annealed and quenched in accordance with the annealing and quenching moulds respectively. In this way, the rigidified intermediate article can be formed.

It will be further understood that the shapes, sizes, dimensions, configurations of the quenching mould (e.g. a female mould) may be the same or substantially the same as those of the intermediate article and optionally those of the final container. As described previously, the gaseous pressure differential can be a positive gas and/or negative gas pressure. For example, a pressurised gas (e.g. to create a positive gas pressure) can be applied to the inner side of the stretched article to urge the article outwardly against the outer moulding surface.

After the intermediate article is rigidified, the annealing and quenching moulds may be moved further apart to allow removal of the rigidified intermediate article. The method may comprise ejecting the rigidified intermediate article by causing a gaseous pressure differential (e.g. a positive gaseous pressure differential) to be applied (e.g. exerted) between an external side and an internal side of the rigidified intermediate article. After quenching, the rigidified intermediate article may adhere to the outer moulding surface of the quenching mould. The exertion of a gaseous pressure differential aids the removal without damaging the rigidified article.

Although the annealing mould and the quenching mould have been described so far as the male mould and the female mould respectively, the present invention also encompasses alternative ways of heating and cooling. In an alternative way, a male mould can be provided which is at the quenching temperature, and a female mould can be provided which is heated to the annealing temperature. During heating, the stretched article can be located within a moulding cavity defined between the male mould and the female mould, and the stretched article is then expanded so as to be placed in contact with the female mould, and removed from contact with the male mould, to anneal said article, and in cooling, the stretched article is shrunk back onto the male mould so as to be placed in contact with the male mould to form the intermediate article, and removed from contact with the female mould, and thereby quenched by contact with the male mould. In a further alternative way, a first female mould is provided which is heated to the annealing temperature, and a second female mould is provided which is at the quenching temperature, and during heating, the stretched article is placed in contact with the first female mould, the stretched article being located within a first moulding cavity of the first female mould. This is to anneal the stretched article. During cooling, the annealed stretched article is placed in contact with the second female mould to form the intermediate article, the intermediate article being located within a second moulding cavity of the second female mould. This is to quench the intermediate article so that it can be rigidified. In still an alternative way, it is also possible to employ a discontinuous “two step” method, in which the received thermoplastic material is stretched to form the stretched article and then cooled to ambient temperature, and optionally stored. Subsequently, the cooled stretched article is reheated to be annealed, forming an intermediate article and the so-formed intermediate article is quenched to be rigidified. It will be further understood that it is possible to employ an alternative version of the ‘two step’ method, in which a plurality of moulds is provided in a mould apparatus, and the received thermoplastic material is stretched to form the stretched article (e.g. by using one of the plurality of the moulds), and subsequently annealed and quenched (e.g. by using further two moulds of the plurality of the moulds).

A skilled worker will further understand that it's possible to form a plurality of intermediate articles along the received thermoplastic material, especially when the thermoplastic material is a sheet (e.g. an elongated sheet). A mould apparatus comprises a plurality of moulds (i.e. 1-stage moulds) mutually spaced to mould (e.g. stretch) the material. A plurality of plugs mutually spaced may be provided. The plugs may be laterally spaced. The plugs and the 1-stage moulds may be configured to engage and stretch respective mutually spaced areas of the received thermoplastic material. The mould apparatus may further comprise a plurality of annealing moulds and quenching moulds. The annealing moulds may be configured to anneal respective mutually spaced stretched articles and the quenching moulds may be configured to quench respective mutually spaced intermediate articles.

The stretched article(s) may be separated from the remainder of the received material before annealing, or after annealing but prior to quenching. Alternatively, the rigidified intermediate article(s) may be separated from the remainder of the material, before, after, or as part of, removal of the further portion.

In the context of the present invention, moulding of the received thermoplastic material typically comprises stretching at least part of said material from an initial thickness to a final thickness, wherein the final thickness is less than 40% of the initial thickness, or less than 30%, or less than 20%, or less than 10%. The at least part of said material preferably corresponds to the substantially horizontal region of the intermediate article. It will be understood that the stretching of the received material (e.g. the received material being a sheet, preferably an elongated sheet) may increase its surface area and decrease its thickness. The level of SIC may increase when the level of stretch increases. Thus, a decreased final thickness indicates high level of SIC, providing enhanced thermostability and increased transparency. Typically, the received thermoplastic material is a sheet (e.g. an extruded sheet). The sheet may comprise some 3-dimensional shaping but in general, the sheet is planar, 2-dimensionally shaped, free from 3-dimensional shaping. The sheet may be formed by blowing, rolling and/or extruding a thermoplastic material. The sheet may be an elongated sheet. Before heated to the first temperature, the sheet can be stored in a roll form. Before being heating, for example at 20 deg C, the sheet typically has a thickness of 0.3 mm to 1.2 mm, optionally 0.4 mm to 0.6 mm, for example 0.5 mm. Said thickness may be constant. But sheets with varying thickness may also be used.

In the context of the present invention, the received thermoplastic material may be unoriented and amorphous. Said material may also be semi-crystalline (e.g. comprise 10% crystallinity or less), and optionally comprises some orientation (e.g. a low degree of biaxial orientation such as 10% or below). Typically, the received thermoplastic material is biaxially orientable. It is understood that the moulding (e.g. stretching) of the received thermoplastic material may cause the received thermoplastic material to be biaxially oriented. In other words, the substantially horizontal region (e.g. the base, and the rim) and the side wall of the intermediate article and of the resultant container may be biaxially oriented.

In the context of the present invention, the received thermoplastic material may comprise (e.g. be) one or more polyesters and/or one or more polypropylenes, optionally one or more polyalkylene polyesters, further optionally one or more polyalkylene polyesters selected from polyethylene terephthalate, polybutylene terephthalate, polyethylene naphthalate and polybutylene naphthalate, yet further optionally one or more polyesters comprising a polyethylene terephthalate (PET), optionally a recycled PET (rPET). Typically, the received thermoplastic material comprises a rPET. The received thermoplastic material may be PET or rPET. In particular, recycled plastics such as rPET can be used, which are usually difficult to use in the context of obtaining strengthened and transparent containers that remain transparent when heated to the design temperature, such as in an oven.

The method may further comprise filling the plastics container with food. The food may be liquid (e.g. soup) or solid (e.g. cheesecake). The food may be a ready meal. The container may be a ready-meal container. Herein, ready-meal refers to food that is partially or wholly prepared and refrigerated, and sold to the consumers for direct consuming or indirect consuming (e.g. via reheating or cooking at home). The container may be a cheesecake container. The container may be a soup container.

The present invention extends to a container obtainable according to the method described hereinbefore. The present invention also extends to a thermoformed container comprising: a base; a rim; and one or more side walls extending between the base and the rim, wherein the rim of the container contains at least 20% SIC throughout. The rim of the container typically remains transparent and does not deform when the container is heated to the design temperature as described herein, for a period of 1 minute, or for other periods as described herein. The shape, dimension, configuration, and other characteristics (e.g., SIC level) of the container may be the same or substantially the same as the intermediate article. In other words, the base, the one or more side walls, the rim of the container may be substantially the same or the same as those of the intermediate article. Preferably, the container does not comprise the further portion (e.g. the further portion is removed from the rigidified intermediate article). That said, the rigidified intermediate article (with the further portion) may also be used as a container. The container may comprise food therein (e.g. soup or cheesecake).

The present invention extends to a mould apparatus for forming the plastics container as described hereinbefore. The mould apparatus is configured to mould a received thermoplastic material to form the intermediate article using the method described hereinbefore. The intermediate article is as described hereinbefore. The mould apparatus may comprise one or more of the following: a stage-1 mould, a plug, an annealing mould and a quenching mould. The mould apparatus may further comprise a cutting apparatus. The mould apparatus and its constituent parts (e.g. stage-1 mould, plug, annealing mould, quenching mould) may be as described herein. It may be that the sizes, dimensions, shapes and configurations of the mould used in the first stage (e.g. the stage-1 mould) correspond respectively to those of the mould used in the second stage. It may be that the sizes, dimensions, shapes and configurations of the plug used in the first stage correspond respectively to those of the plug used in the second stage. Herein, ‘correspond’ may be understood to mean the same or substantially the same.

The present invention further extends to a mould for use in the mould apparatus described hereinbefore. The mould comprises a mould surface for moulding thermoplastic material thereon. The mould surface defines: a base; one or more side walls extending therefrom; and a further portion having a surface area greater than 20% greater than a projected surface area of the further portion, projected onto a plane of the base, the further portion extending from a substantially horizontal region of the intermediate article having a surface area less than 20% greater than a projected surface area of the substantially horizontal region of the intermediate article, projected onto the plane of the base.

The mould may be a male mould, or a female mould. The mould may include substantially any features as described hereinbefore.

### DESCRIPTION OF THE FIGURES

Example embodiments of the present invention will now be illustrated with reference to the following non-limiting Figures in which:

FIG. 1 shows a perspective view of a part of a mould apparatus according to an embodiment of the present invention;

FIG. 2 shows a cross-sectional view of the part of the mould apparatus shown in FIG. 1;

FIG. 3 shows a stretched article obtainable from the part of the mould apparatus shown in FIGS. 1 and 2;

FIG. 4 shows a perspective view of another part of a mould apparatus according to an embodiment of the present invention;

FIG. 5 shows a cross sectional view of the part of the mould apparatus shown in FIG. 4;

FIG. 6 shows an intermediate article obtainable from the part of the mould apparatus shown in FIGS. 4 and 5;

FIG. 7 shows a container according to an embodiment of the present invention;

FIG. 8 is a flow chart of a method according to an embodiment of the present invention.

FIG. 9 shows a perspective view of a mould station according to an embodiment of the present invention;

FIG. 10 shows a perspective view of a mould station comprising multiple quenching moulds and an annealing mould according to an embodiment of the present invention;

FIG. 11a shows a perspective view of the annealing mould shown in FIG. 10;

FIG. 11b shows a perspective view of the quenching mould shown in FIG. 10; and

FIG. 12 shows a cross-sectional view of the annealing mould and the quenching mould shown respectively in FIGS. 11a and b.

In the Figures, like parts are denoted by like reference numerals.

### DETAILED DESCRIPTION OF THE EXAMPLE EMBODIMENT

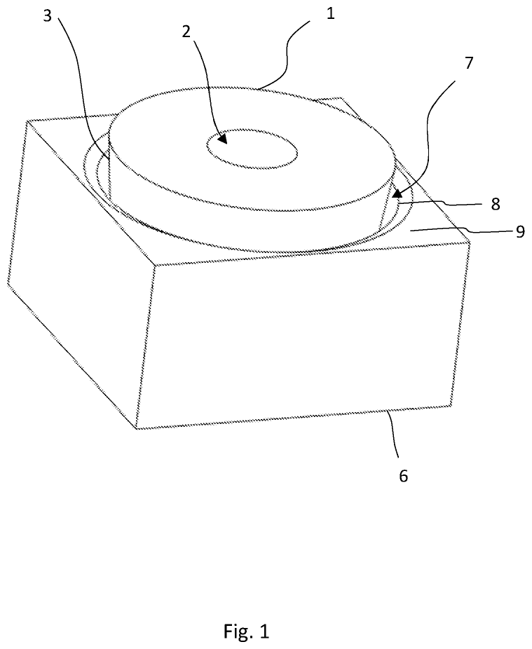

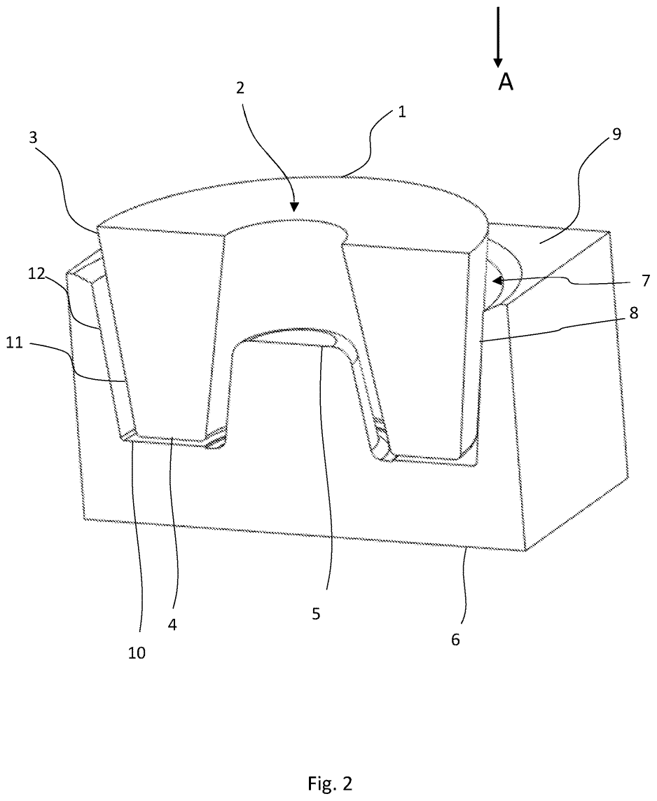

In detail, FIG. 1 and FIG. 2 show a perspective view and a cross-sectional view, respectively, of a matched pair of male and female moulds for a first mould stage of a mould apparatus for forming a stretched article according to an embodiment of the present invention. The forming of the stretched article uses a male mould in the form of a plug 1 having a through-opening 2 and a moulding surface 3. The plug 1 comprises an end 4 configured to engage and stretch a received thermoplastic material. With the through-opening 2, the plug 1 is configured to accommodate and stretch a part of the received thermoplastic material that corresponds to a protrusion in the stretched article. The stretched article itself is not shown in FIG. 1 or 2, but a respective protrusion 5 (in a frustoconical shape) comprised in a female mould 6 is shown in FIG. 2. The female mould 6 has a mould cavity 7 surrounded by an outer moulding surface 8, which defines the outer shape of the stretched article. The plug 1 is configured to be axially moveable relative to the female mould 6. The plug 1 can be aligned with the female mould 6.

During operation, the plug 1, the female mould 6 and the received thermoplastic material (not shown) are heated to at least the first temperature (e.g. 120 °C). The received material is positioned between the female mould 6 and the plug 1, provided in an axially spaced arrangement where the end 4 of the plug 1 is clear of an upper surface 9 of the female mould 6. The received material is typically provided in the form of a sheet, provided parallel to the upper surface 9 of the female mould 6. A clamping member (not shown) is provided as part of the moulding apparatus, movable with the plug 1 and is used to clamp the received thermoplastic material between the clamp and the upper surface 9 of the female mould as the plug 1 is moved towards the female mould 6. In this way, the received material may seal the moulding cavity 7. After sealing, the moulding cavity 7 can be subjected to a vacuum pressure by extracting air from a series of vacuum ports (not shown) located in the outer moulding surface 8 to create a negative pressure differential between the side of the received thermoplastic material facing the moulding cavity and an opposite side of the received thermoplastic material. Then, the plug 1 moves in an axial direction (i.e. downwardly as indicated by arrow A in FIG. 2) towards the female mould 6 to engage the received thermoplastic material, which causes the material to deform and stretch towards the bottom 10 of the mould cavity 7. This may cause the received material to form a conical or frustoconical shape, having an axis aligned with the plug 1. In other words, the plug 1 moves towards the bottom 10 to stretch the received material. The speed of the movement of the plug is 0.5 m/s. When the plug 1 finishes moving, the plug 1 and the female mould 6 are in a closed configuration (as illustrated in FIGS. 1 and 2). The gap between the end 4 of the plug and the bottom 10 of the mould cavity 7 in the closed configuration is about 6 mm or less, and the gap between the side 11 of the moulding surface 3 and the side 12 of the outer moulding surface 8 is about 7 mm. Afterwards, a pressurized gas is wholly or partly emitted from the plug 1, to urge the received thermoplastic material in a direction towards the outer moulding surface 8. In this way, the material is urged by the gas to contact and assume the shape of the outer moulding surface 8, thereby forming a stretched article. The presence of the protrusion 5 facilitates the stretching of the base of the stretched article (i.e. the part of the received material that assumes the shape of the bottom 10 of the mould cavity 7). Thus, the base may contain at least 20% SIC in a region of the base near the corner between the base and the portion of the stretched article formed by the protrusion 5.

Furthermore, the length of the side 12 is longer than the depth of the container to be formed, meaning that a portion of the material of the stretched article provided towards the upper end of the side 12 is used to form a rim of the container, as will be described further hereinafter.

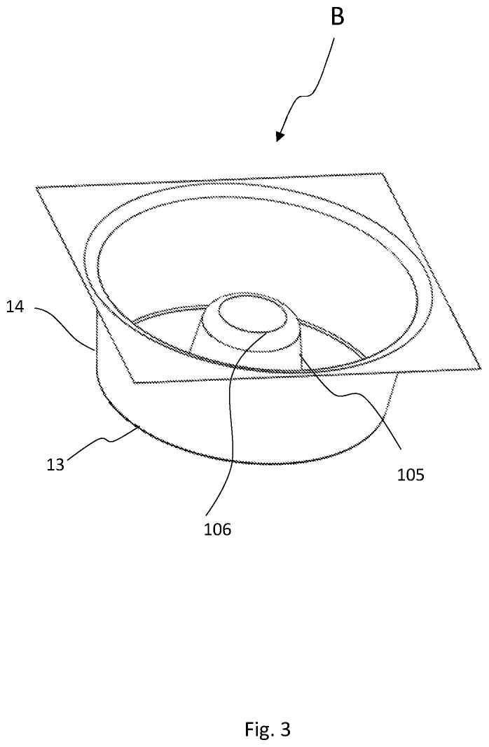

FIG. 3 shows a stretched article B, obtainable according to the above-described operation during the first mould stage. The article B comprises a base 13 comprising a substantially horizontal region. A protrusion 105 extending from said substantially horizontal region. The protrusion 105 comprises a top surface 106. The stretched article B further comprises a sidewall 14 extending from the base 13.

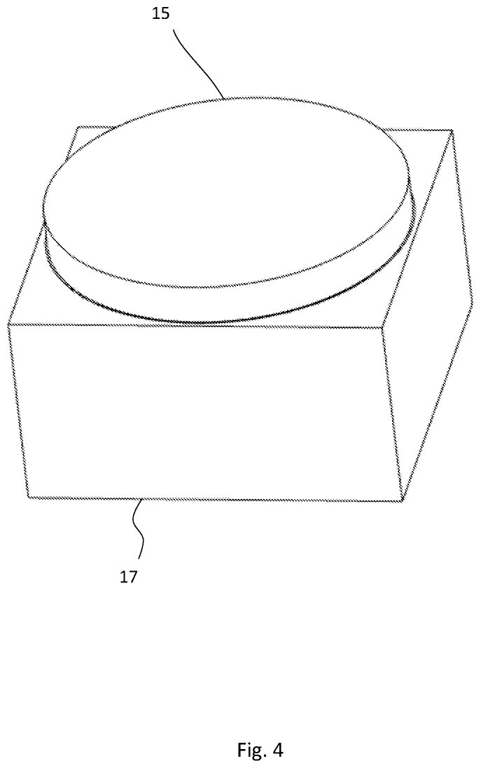

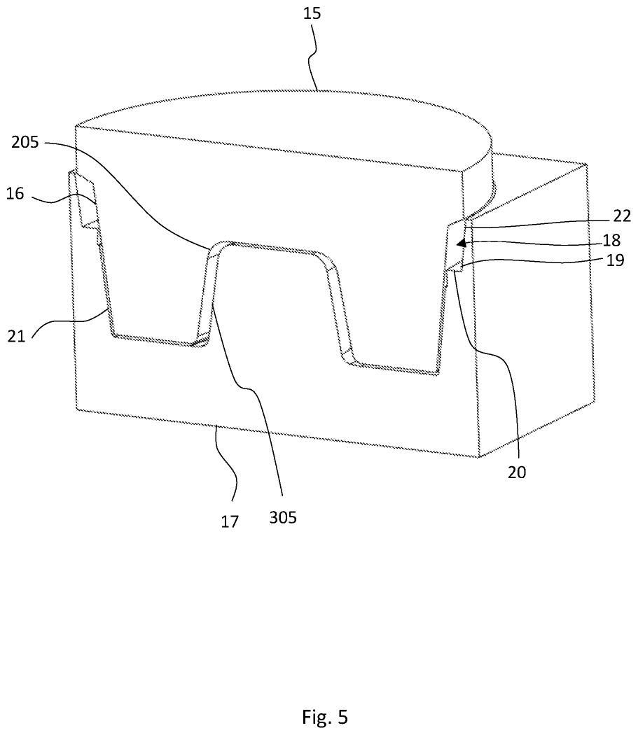

FIGS. 4 and 5 show the perspective view and the cross-sectional view, respectively, of a further matched pair of male and female moulds for a second mould stage of the mould apparatus for transforming a stretched article to an intermediate article according to an embodiment of the present invention. An annealing mould 15 is a male mould (taking the form of a plug), having a moulding surface 16. A quenching mould 17 is a female mould having a cavity 18 surrounded by an outer moulding surface 19. The outer moulding surface 19 defines an outer shape of an intermediate article (not shown in FIGS. 4 and 5). The annealing mould 15 comprises an inverted protrusion 205 forming a recess, and the quenching mould 17 comprises a correspondingly upright protrusion 305 having a substantially similar shape to inverted protrusion 205 but being smaller in size.

During operation, the annealing mould 15 is heated to a temperature greater than the first temperature (e.g.170 °C). The quenching mould 17 is cooled to a quenching temperature (e.g. 70 °C). The quenching mould 17 is located below the annealing mould 15 as shown in FIGS. 4 and 5. The two moulds are spaced by a gap of about 0.6 cm when in a closed configuration (as shown in FIGS. 4 and 5). However, the annealing mould 15 and the quenching mould 17 are first moved apart in an axial direction to allow the material formed into the shape of the stretched article to be inserted therebetween. The annealing mould 15 is then moved towards the quenching mould 17 into the closed configuration, such that the stretched article is provided in the gap between the two moulds. As part of this, the stretched article is brought into contact with the annealing mould 15 in order to anneal the material forming the stretched article. The stretched article may be annealed for about 1 second. Then, the annealed stretched article is expanded so as to be removed from contact with the annealing mould 15 and be placed in contact with the cooler quenching mould 17 to rigidify the annealed material to form an intermediate article (not shown in FIG. 4 and 5). The stretched article can be expanded by: (i) passing pressurised gas through the annealing mould 15 to apply a positive gas pressure against an inner side of the stretched article in contact with the annealing mould, and/or (ii) applying a negative gas pressure (e.g. vacuum) to a series of vacuum ports (not shown) which are located in the outer moulding surface 19. The positive gas pressure pushes, and the vacuum pressure sucks, an outer surface of the annealed stretched article against the quenching mould 17 and spaces the annealed stretched article from the hotter annealing mould 15. The annealed stretched article is urged outwardly towards the quenching mould 17 to assume the shape of the outer moulding surface 19, thereby forming the intermediate article. The outer moulding surface 19 comprises a substantially horizontal region 20 extending from a side wall 21. The substantially horizontal region 20 facilitates the formation of the rim in the intermediate article. The outer moulding surface 19 comprises a further portion 22 extending from the substantially horizontal region 20. Said further portion 22 permits the formation of a corresponding further portion (e.g. extending upwardly from the rim) in the intermediate article. The intermediate article stays in the quenching mould 17 and is cooled to the quenching temperature in about 2 seconds. The intermediate article may stay longer than 2 seconds in the quenching mould or so long as it needs, to result in a rigidified intermediate article. Afterwards, the rigidified intermediate article is released from (e.g. removed from) the quenching mould 17 by ejecting (e.g. blowing) a pressurised gas against the outer surface of said article that is in contact with said mould 17.

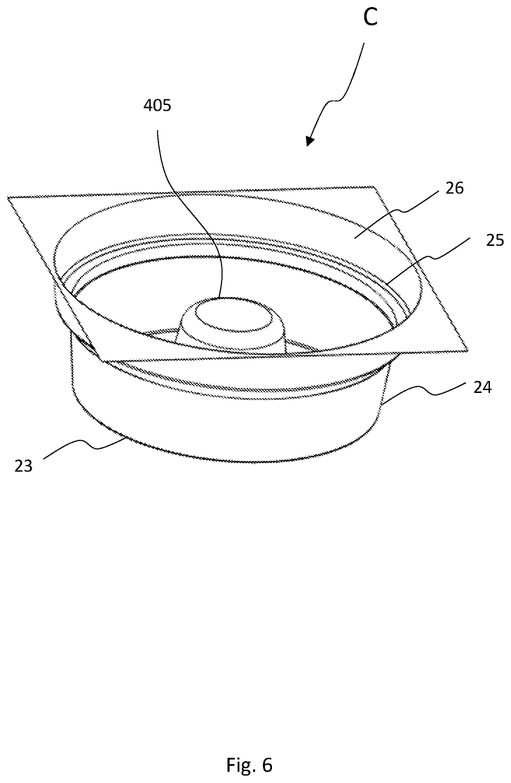

FIG. 6 shows an intermediate article C, obtainable according to the above-described operation during the second mould stage. The intermediate article C comprises a side wall 24, a first substantially horizontal region 25 (i.e. a rim) extending from the side wall 24, and a first further portion 26 extending (e.g. upwardly) from the rim 25. The rim 25 contains at least 20% SIC throughout, because the originating part of the received thermoplastic material corresponding to the rim 25 has been properly stretched during the first mould stage (i.e. the operation to form the stretched article), concurrently with stretching the originating part that corresponds to the side wall 24. The intermediate article C further comprises a base 23 comprising a second substantially horizontal region, and a protrusion 405 extending from the second substantially horizontal region. The protrusion 405 is understood as a second further portion. As shown in FIGS. 6, the side wall 24 extends between the rim 25 and the base 23. It is further understood that the side wall 24 contains at least 20% SIC throughout. The base 23 may also contain at least 20% SIC over at least 50% of the base 23 since the presence of protrusion facilitates sufficient stretching of at least some of the originating part of the received material that corresponds to the base. The first further portion 26 and the protrusion 405 (i.e. the second further portion) typically contain at least some regions having less than 20% SIC. It is possible that 26 and 405 each contain less than 20% SIC throughout.

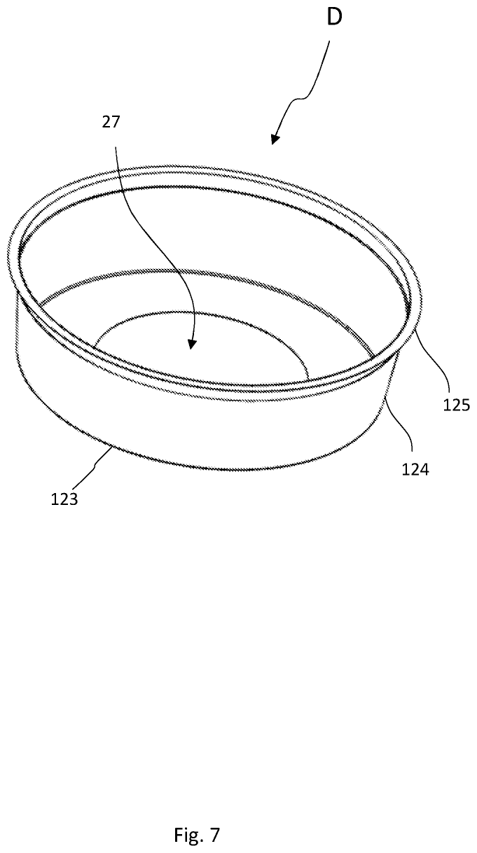

FIG. 7 shows a container D. The intermediate article C is quenched to obtain the rigidified intermediate article and subsequently removed from the quenching mould. The first further portion 26 (not shown) and the protrusion 405 which is the second further portion (not shown) are removed (e.g. cut or trimmed off) from the rigidified intermediate article to obtain the container D. The container D comprises a base 123 comprising an opening 27, a rim 125 and a side wall 124 extending between the rim 125 and the base 123. The rim 125 contains at least 20% SIC throughout. The container D is a cheesecake container.

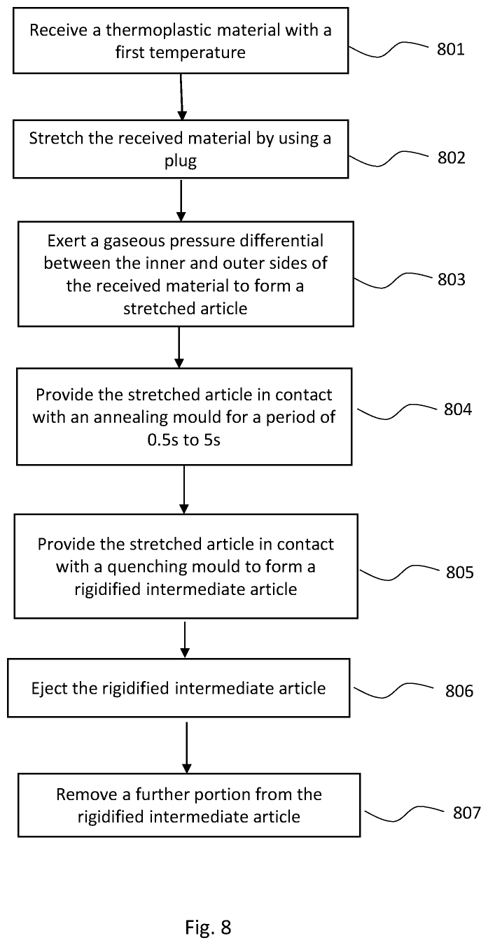

FIG. 8 shows a flow chart of a method for forming a plastics container in accordance with an embodiment of the present invention. In step 801, a thermoplastic material is received. The received material has a first temperature (T) greater than the glass transitional temperature (Tg) but below the melting temperature (Tm) of said material. In step 802, the received material is stretched by using a plug. This stretching is sufficient to cause at least 20% SIC in at least some areas of the received material. Then, a gaseous pressure differential is exerted to the inner and outer sides of the received material (step 803). In this way, a stretched article is formed. The stretched article may comprise a base, one or more side wall extending therefrom, and a further portion. If the plastics container comprises a rim, it is understood that an originating part of the received material that corresponds to the rim has already been stretched by this stage. In step 804, the stretched article is provided in contact with an annealing mould for a period of from 0.5 second to 5 seconds. The annealing mould is heated to at least an annealing temperature which is above T. After annealing, in step 805, the annealed stretched article is removed from contact with the annealing mould and provided in contact with a quenching mould to form an intermediate article. The intermediate article may comprise a rim containing at least 20% SIC, because the originating part corresponding to the rim has been sufficiently stretched to provide this high level of SIC. The further portion extends from the rim. The intermediated article is quenched (by the quenching mould that has a quenching temperature below Tg) to provide a rigidified intermediate article. In step 806, the method provides ejecting the rigidified intermediate article (e.g. from the quenching mould). The rigidified intermediate article may be ejected by applying a gaseous pressure differential between an external side and an internal side of the rigidified intermediate article. Finally, in step 807, the further portion is removed (e.g. cut or trimmed off) from the rigidified intermediate article.

Although the present disclosure has described portions of the container having at least 20% SIC, it may alternatively or additionally be stated that the same portions of the container have undergone a thickness reduction compared to the originating portions of the received thermoplastic material of at least 60%.

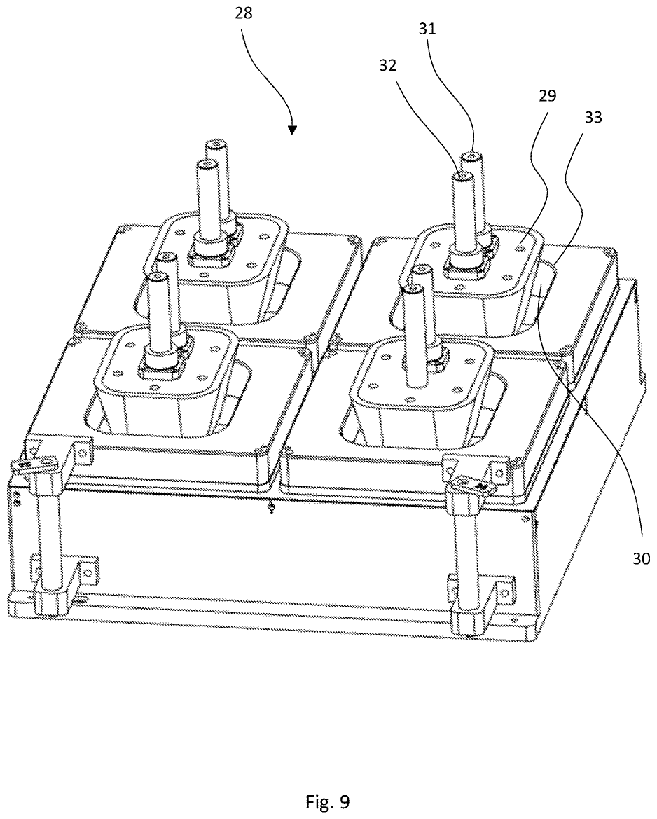

FIG. 9 shows a perspective view of a mould station 28 according to an embodiment of the present invention. The station comprises four sets of male and female moulds for a first moulding stage of a mould apparatus for forming stretched articles. Each set has a male mould in the form of a plug 29 and a corresponding female mould 30. The plug 29 is configured to be axially moveable relative to the female mould 30 by two driving rods (31, 32). The plug 29 is aligned with the female mould 30. The plug 29 and the female mould 30 are similar to those described in FIGS. 1 and 2 except the following differences. The plug 29 does not comprise a through-opening and the mould 30 does not comprise a protrusion (in a frustoconical shape). The female mould 30 comprises a slippery region optionally a region around the rim 33 of the mould 30. The region may be made from PTFE or be provided with a slippery coating (made from PTFE). The female mould 30 may be made from PTFE. The operation details of the plug 29 and the mould 30 are as described in FIGS. 1 and 2. In FIG. 9, the plug 29 and the female mould 30 are shown in their open configuration with the plug and the mould spaced apart from each other. Thus, a received material (not shown) may be provided between the plug 29 and the mould 30, and be subsequently stretched by the plug 29 towards the bottom of the moulding surface of the female mould 30, thereby forming a stretched article. The mould 30 (without the protrusion) and the plug 29 (without the through-opening) may be suitable for making a container without an opening in the base (e.g. the opening 27 as shown in container D). The container may be suitable for soup and ready meals.

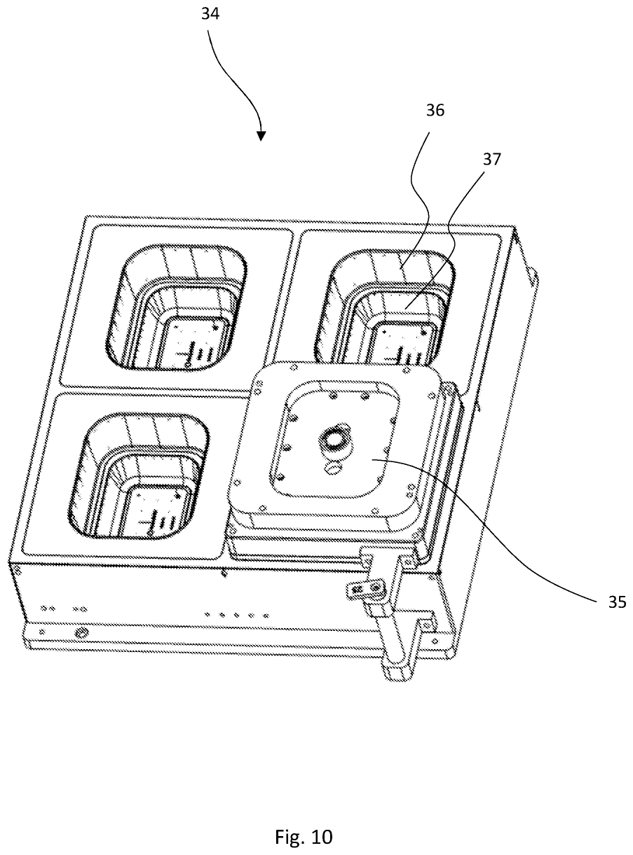

FIG. 10 shows a perspective view of a mould station 34 comprising four quenching moulds and an annealing mould according to an embodiment of the present invention; these are for a second moulding stage of the mould apparatus for transforming a stretched article to an intermediate article. The annealing mould 35 takes the form of a plug having a moulding surface (not shown); and the quenching mould 36 is a female mould having an outer moulding surface 37 defining the outer shape of the intermediate article (not shown). Although only one of the quenching moulds in FIG. 10 is provided with a matched annealing mould 35, it is understood that during operation, the quenching moulds and the annealing moulds are provided as matched pairs. The operation details of the plug 35 and the mould 36 are as described in FIGS. 4 and 5. In FIG. 10, the plug 35 is in a closed configuration with respect to its corresponding female mould, allowing an intermediate article (not shown) to be disposed therebetween. The annealing mould 35 (without the inverted protrusion 205 as shown in FIG. 5) and the quenching mould 36 (without the upright protrusion 305 as shown in FIG. 5) may be suitable for making a container without an opening in the base (e.g. the opening 27 as shown in container D). The container may be suitable for soup and ready meals.

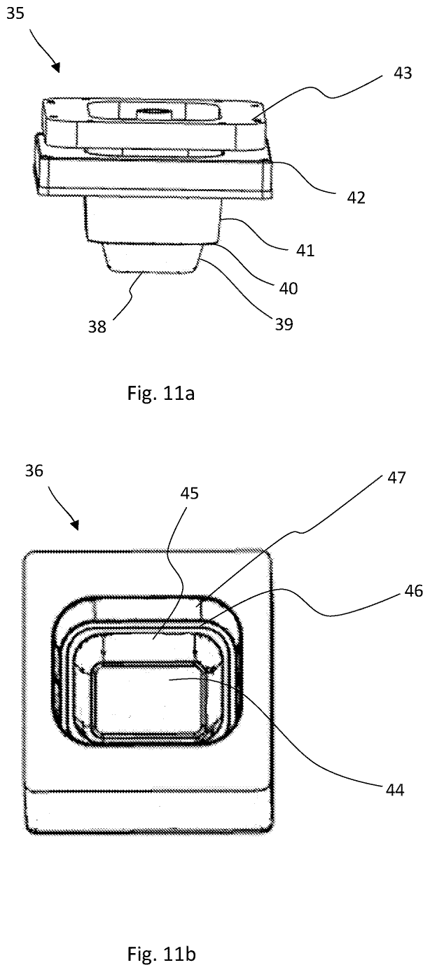

FIG. 11a shows a perspective view of the annealing mould 35 shown in FIG. 10. The mould 35 takes the form of a plug. The mould 35 comprises a base 38, a sidewall 39 and a substantially horizontal region 40. The sidewall 39 extends between the substantially horizontal region 40 and the base 38. The mould 35 also comprise a further portion 41 extending from the horizontal region 40. The further portion 41 is a relatively steep portion with respect to the base 38 and the substantially horizontal region 40. The rim of the annealing mould 35 comprises the substantially horizontal region 40. The base 38, the sidewall 39, the substantially horizontal region 40 (e.g. at least part of the rim), and the further portion 41 together provides at least part of the moulding surface of the annealing mould 35. The mould 35 may have a ring portion 42, which is configured to clamp the mould 35 onto the mould station 34 (not shown). The mould 35 may contain a mounting plate 43, which is configured to mount the mould 35 to a top of the mould station (not shown) for the second mould stage.

FIG. 11b shows a perspective view of the quenching mould 36 shown in FIG. 10. The quenching mould 36 comprises a base 44, a sidewall 45 extending therefrom, and a substantially horizontal region 46. The sidewall 45 extends between the substantially horizontal region 46 and the base 44. The mould 36 also comprises a further portion 47 extending from the horizontal region 46. The rim of the quenching mould 36 comprises the substantially horizontal region 46. The further portion 47 is a relatively steep portion with respect to the base 44 and the substantially horizontal region 46. The base 44, the sidewall 45, the substantially horizontal region 46 and the further portion 47 together define at least part of the outer moulding surface 37 as shown in FIG. 10 which defines the outer shape of the intermediate article (not shown).

The shapes and configurations of the base 38, the sidewall 39, the substantially horizontal region 40 and the further portion 41 of the annealing mould 35 may be the same or substantially the same with respect to the shapes and configurations of their corresponding parts 44, 45, 46 and 47 of the quenching mould 36; and the sizes and dimensions of 38, 39, 40 and 41 may be reduced with respect to the sizes and dimensions of their corresponding parts 44, 45, 46 and 47. When the annealing mould 35 and the quenching mould 36 are in a closed configuration, the annealing mould 35 is at least partially inserted into the quenching mould 36. During operation, a part of the stretched article can be clamped by the substantially horizontal region 40 (e.g. the rim) of the annealing mould 35 and the corresponding region 46 (e.g. the rim) of the quenching mould 36, thereby forming at least part of a rim of the intermediate article (or at least part of a rim of the final container). The further portions 41 and 47 permits the formation of a corresponding further portion in the intermediate article (not shown). Said corresponding further portion in the intermediate article may be removed in the final container.

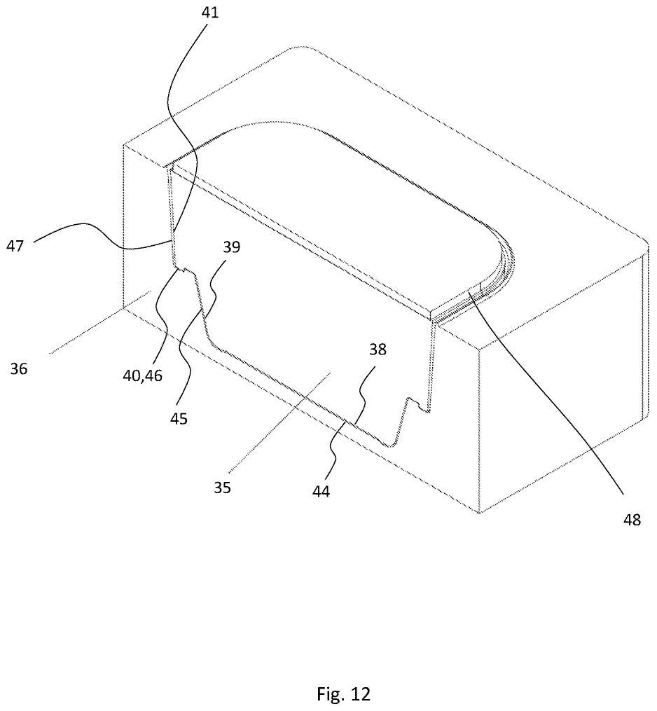

FIG. 12 shows a cross-sectional view of the annealing mould 35 and the quenching mould 36 shown respectively in FIG. 11a and FIG. 11b. The annealing mould 35 and the quenching mould 36 are shown as a matched pair in their closed configuration with the annealing mould 35 inserted into the mould cavity of the quenching mould 36. The bases 38, 44 of the moulds face each other with a gap therebetween, and the same are shown for the sidewalls 39, 45. Said gap may be as described herein (e.g. 10 about 0.6 cm or less). At least part of the intermediate article (not shown) such as the base and the side wall of the intermediate article can be provided in the gap between the two moulds. It is understood that FIG. 12 is not to scale to show the exact gap during use of the moulds. In FIG. 12, the substantially horizontal regions 40, 46 of the moulds clamp against each other. The base 38, the sidewall 39, the substantially horizontal region 40 and the further portion 41 of the annealing mould 35 are as described in FIG. 11a; the base 44, the sidewall 45, the substantially horizontal region 46 and the further portion 47 of the quenching mould 36 are as described in FIG. 11b.

FIG. 12 shows the substantially horizontal region 40 of the annealing mould 35 and the corresponding substantially horizontal region 46 of the quenching mould 36 clamp against each other. Therefore, during operation, a part of the stretched article (not shown) positioned between the annealing mould 35 and the quenching mould 36 is clamped by a portion of the annealing mould and a corresponding portion of the 25 quenching mould, thereby forming a rim of the intermediate article. The portion of the annealing mould may comprise the horizontal region 40 and the portion of the quenching mould may comprise the horizontal region 46. Said rim may also be the rim of the final container (if the further portion of the rigidified intermediate article is removed).

In FIG. 12, the mould 35 comprises a (top) plate 48 positioned opposite the base 38. The plate 48 is an insulating plate (e.g. made from an insulating material). This plate 48 is not visible in FIG. 11a because its view is concealed by the ring portion 42. During operation, the plate 48 reduces the risk of overheating other parts (e.g. the ring portion 42, the mounting plate 43) of the mould 35. When the annealing mould 35 and the quenching mould 36 are in a closed configuration as shown in FIG. 12, the plate 48 also reduces or prevents heat loss, i.e. the plate 48 helps to localise the heat within the mould cavity to efficiently anneal the stretched article.

In summary, the present disclosure provides a method of forming a plastics container, the container so formed, and a kit in parts for use in the method. The method comprises receiving (801) a thermoplastic material, the thermoplastic material having a first temperature above the glass transition temperature and below a melting temperature of said thermoplastic material; and moulding the received thermoplastic material to form an intermediate article defining: a base; one or more side walls extending therefrom; and a further portion having a surface area greater than 20% greater than a projected surface area of the further portion, projected onto a plane of the received thermoplastic material, the further portion extending from a substantially horizontal region of the intermediate article having a surface area less than 20% greater than a projected surface area of the substantially horizontal region of the intermediate article, projected onto the plane of the received thermoplastic material, wherein the moulding of the received thermoplastic material comprises: stretching (802) the received thermoplastic material to provide at least 20% strain-induced crystallinity (SIC) across the substantially horizontal region of the intermediate article, and heating (804) to an annealing temperature greater than the first temperature for a period of from 0.5 second to 5 seconds, and subsequently cooling (805) to a quenching temperature below the glass transition temperature to provide a rigidified intermediate article

Throughout the description and claims of this specification, the words “comprise” and “contain” and variations of them mean “including but not limited to”, and they are not 25 intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise. Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. Numerical ranges expressed in the format ‘from x to y’ and ‘between x and y’ are understood to include x and y, unless specified otherwise. When for a specific feature multiple optional ranges are described, it is understood that all ranges combining the different endpoints are also contemplated. Except in the operating and comparative examples, or where otherwise explicitly indicated, all numbers in this description indicating amounts of material or conditions of reaction, physical properties or materials and/or use are to be understood as modified by the word ‘about’.

1. A method of forming a plastics container, the method comprising:
receiving a thermoplastic material, the thermoplastic material having a first temperature above the glass transition temperature and below a melting temperature of said thermoplastic material; and
moulding the received thermoplastic material to form an intermediate article defining:
a base;
one or more side walls extending therefrom; and
a further portion having a surface area greater than 20% greater than a projected surface area of the further portion, projected onto a plane of the received thermoplastic material, the further portion extending from a substantially horizontal region of the intermediate article having a surface area less than 20% greater than a projected surface area of the substantially horizontal region of the intermediate article, projected onto the plane of the received thermoplastic material,
wherein the moulding of the received thermoplastic material comprises:
stretching the received thermoplastic material to provide at least 20% strain-induced crystallinity, SIC, across the substantially horizontal region of the intermediate article; and
heating to an annealing temperature greater than the first temperature for a period of from 0.5 second to 5 seconds, and subsequently cooling to a quenching temperature below the glass transition temperature to provide the rigidified intermediate article.

2. The method according to claim 1, further comprising removing the further portion from the rigidified intermediate article.

3. The method according to claim 1, wherein stretching the received thermoplastic material comprises stretching an originating part of the received thermoplastic material that corresponds to the further portion to provide the at least 20% SIC across the substantially horizontal region of the intermediate article.

4. (canceled)

5. The method according to claim 1, wherein the plane of the received thermoplastic material is the plane of the base of the intermediate article when formed.

6. The method according to claim 1, wherein the substantially horizontal region provides a rim, and wherein the one or more side walls extend between the base and the rim, and wherein the further portion extends from the rim opposite the base.

7. (canceled)

8. The method according to claim 6, wherein the rim is formed by stretching an originating part of the received thermoplastic material that corresponds to the rim, and subsequently exerting a gaseous pressure differential between the inner and outer sides of said part to urge said part outwardly away from the base.

9. The method according to claim 1, wherein the base comprises the substantially horizontal region, and the further portion extends from the substantially horizontal region to form a protrusion with respect to the base, and wherein the substantially horizontal region defines an annular region surrounding the protrusion.

10. (canceled)

11. The method according to claim 1, wherein the first temperature is between 80 °C and 200 °C, and the annealing temperature is at least 150 °C but not more than 250 °C.

12. (canceled)

13. The method according to claim 1, wherein moulding the received thermoplastic material comprises using a plug to stretch at least part of said material, and subsequently exerting a gaseous pressure differential between the inner and outer sides of the at least part of said material to form a stretched article.

14. The method according to claim 13, wherein the actuation speed of the plug relative to the received thermoplastic material is at least 0.5 metre per second.

15. The method according claim 13, wherein the heating and the subsequently cooling comprises:
providing the stretched article in contact with an annealing mould for a period of from 0.5 second to 5 seconds, the annealing mould heated to at least the annealing temperature;
removing the stretched article from contact with the annealing mould and providing the stretched article in contact with a quenching mould to form the intermediate article, wherein the quenching mould is at or below the quenching temperature, thereby quenching to provide the rigidified intermediate article.

16. The method according to claim 15, comprising clamping a part of the stretched article corresponding to a rim of the container by a portion of the annealing mould and a corresponding portion of the quenching mould, thereby forming said rim.

17. The method according to claim 15, wherein the heating and the subsequently cooling comprises spacing the annealing mould and the quenching mould by a gap of from 0.5 cm to 2 cm.

18. The method according to claim 1, comprising ejecting the rigidified intermediate article by causing a gaseous pressure differential to be applied between an external side and an internal side of the rigidified intermediate article.

19. (canceled)

20. (canceled)

21. A thermoformed plastics container comprising:
a base;
a rim; and
one or more side walls extending between the base and the rim, wherein the rim of the container contains at least 20% strain-induced crystallinity (SIC) throughout.

22. A thermoformed plastics container manufactured according to the method of claim 1.

23. (canceled)

24. (canceled)

25. A mould apparatus for forming a plastics container comprising
a base;
a rim; and
one or more side walls extending between the base and the rim, wherein the rim of the container contains at least 20% strain-induced crystallinity (SIC) throughout, and
wherein the mould apparatus is configured to mould a received thermoplastic material to form the intermediate article, according to the method of claim 1.

26. A mould for use in the mould apparatus of claim 25, wherein the mould comprises a mould surface for moulding thermoplastic material thereon, the mould surface defining:
a base;
one or more side walls extending therefrom; and
a further portion having a surface area greater than 20% greater than a projected surface area of the further portion, projected onto a plane of the base, the further portion extending from a substantially horizontal region of the intermediate article having a surface area less than 20% greater than a projected surface area of the substantially horizontal region of the intermediate article, projected onto the plane of the base.

27. A mould for use in the mould apparatus of claim 25, wherein the mould comprises a region formed from a material having a lower coefficient of friction (COF) than that of the material forming a further mould, wherein the further mould comprises a mould surface for moulding thermoplastic material thereon, the mould surface defining:
a base;
one or more side walls extending therefrom; and
a further portion having a surface area greater than 20% greater than a projected surface area of the further portion, projected onto a place of the base, the further portion extending from a substantially horizontal region of the intermediate article having a surface area less than 20% greater than a projected surface area of the substantially horizontal region of the intermediate article, projected onto the plane of the base.

28. A mould apparatus according to claim 25 comprising an annealing mould and a quenching mould, wherein the annealing mould and the quenching mould are configured to clamp a part of the stretched article therebetween to form a rim of the container.
